(19) United States
(12) Patent Application Publication
(10) Pub. No.: US 2016/0253510 A1
(43) Pub. Date: Sep. 1, 2016

(54) METHOD FOR SECURITY AUTHENTICATION AND APPARATUS THEREFOR

(71) Applicant: GCOD INNOVATION CO., LTD., Seoul (KR)

(72) Inventor: Yong-Hoon Lim, Goyang (KR)

(73) Assignee: GCOD INNOVATION CO., LTD., Seoul (KR)

(21) Appl. No.: 14/424,822

(22) PCT Filed: Jul. 24, 2014
(86) PCT No.: PCT/KR2014/006769

§ 371 Date: Feb. 27, 2015

(30) Foreign Application Priority Data
Sep. 12, 2013 (KR) 10-2013-0109897
Nov. 15, 2013 (KR) 10-2013-0139284
Jun. 12, 2014 (KR) 10-2014-0071632

(51) Int. Cl. G06F 21/62; G06F 21/84; H04L 29/06

(52) U.S. Cl. CPC G06F 21/6218; H04L 63/083; G06F 21/84

(57) ABSTRACT

Disclosed is a security authorization method for protecting user data safely from external hacking and an apparatus therefor, and the security authorization method which performs security authentication of a user according to the present disclosure includes receiving, by a safety input apparatus, virtual data including a virtual code for each object from an authentication server, outputting, by the safety input apparatus, a plurality of object selection interfaces in which each object is placed and a location of each object is changeable, setting, by the safety input apparatus, when the location of each object is decided, a plurality of objects placed at the same location in each object selection interface as a combination set, ascertaining, by the safety input apparatus, the virtual code of each object in the virtual data, and combining the virtual code of each object by the set combination set to generate a plurality of multi virtual codes distinguished by the combination set, and transmitting, by the safety input apparatus, the plurality of generated multi virtual codes as authentication information of a user to the authentication server.

### TECHNICAL FIELD

The present disclosure relates to security authentication technology, and more particularly, to a security authentication method for protecting user data safely from external hacking and an apparatus therefor.

The present application claims priority to Korean Patent Application No. 10-2013-0109897 filed on Sep. 12, 2013 in the Republic of Korea, Korean Patent Application No. 10-2013-0139284 filed on Nov. 15, 2013 in the Republic of Korea, and Korean Patent Application No. 10-2014-0071632 filed on Jun. 12, 2014 in the Republic of Korea, the disclosures of which are incorporated herein by reference.

### BACKGROUND ART

As a common method for user authentication, a password authentication method is being used. The password authentication method stores a password initially inputted from a user, compares a user inputted password to the previously stored password whenever needed, and when they are identical, and determines that the password authentication is successful. Also, technology for authenticating a user using a touch pattern set by the user, evolved from a traditional password authentication method, was disclosed. Korean Patent Application Publication No. 10-2009-0013432 discloses a mobile terminal for authenticating a user using a pattern and its locking and unlocking method.

However, a password has various probabilities of leak. For example, a password may be stolen from a third party having peeped a password input process of a user. Also, a password inputted in a user terminal may be hacked by a hacking program.

Accordingly, there is a need for a password authentication method which deactivates a password of a user leaked to a third party, and along with this, a password input method which protects a password of a user from a sniffing attack and the like.

### DISCLOSURE

### Technical Problem

The present disclosure is designed to solve the problem of the related art, and therefore the present disclosure is directed to providing a security authentication method which safely protects authentication data of a user from a sniffing attack and hacking by a malicious code and an apparatus therefor.

Also, the present disclosure is directed to providing a security authentication method which prevents secret data of a user from being revealed even if an authentication data input screen is leaked and an apparatus therefor.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Technical Solution

In one aspect of the present disclosure, there is provided a method which performs security authentication of a user, including receiving, by a safety input apparatus, virtual data including a virtual code for each object from an authentication server, outputting, by the safety input apparatus, a plurality of object selection interfaces in which each object is placed and a location of each object is changeable, setting, by the safety input apparatus, when the location of each object is decided, a plurality of objects placed at the same location in each object selection interface as a combination set, ascertaining, by the safety input apparatus, the virtual code of each object in the virtual data, and combining the virtual code of each object by the set combination set to generate a plurality of multi virtual codes distinguished by the combination set, and transmitting, by the safety input apparatus, the plurality of generated multi virtual codes as authentication information of a user to the authentication server.

In another aspect of the present disclosure, there is provided a safety input apparatus including an interface generation unit configured to receive virtual data including a virtual code for each object, and generate and output a plurality of object selection interfaces in which each object is placed and a location of each object is changeable, and a multi virtual code generation unit configured to, when the location of each object is decided, set a plurality of objects placed at the same location in each object selection interface as a combination set, ascertain the virtual code of each object in the virtual data, and combine the virtual code of each object by the set combination set to generate a plurality of multi virtual codes distinguished by the combination set as authentication information of a user.

In another aspect of the present disclosure, there is provided an authentication apparatus including a storage unit configured to store a plurality of secret objects set by a user, a virtual data providing unit configured to generate a virtual code for each of the plurality of secret objects and a plurality of masquerading objects, and transmit virtual data including the generated virtual code of each object to a communication device of the user, and an authentication unit configured to authenticate the user, when receiving a plurality of multi virtual codes generated by the communication device from the communication device based on an input signal of the user and the virtual data, by ascertaining whether there is a multi virtual code corresponding to an authentication code among the plurality of multi virtual codes.

In another aspect of the present disclosure, there is provided a safety input apparatus including a storage unit configured to store a plurality of secret objects set by a user, an interface generation unit configured to generate and output a plurality of object selection interfaces in which each object is placed and a location of each object is changeable, and an authentication unit configured to authenticate the user by, when the location of each object in the object selection interface is decided, setting a plurality of objects placed at the same location in each object selection interface as a group, and ascertaining whether there is a group including all of the plurality of secret objects stored in the storage unit among the set groups.

In another aspect of the present disclosure, there is provided a method which performs security authentication of a user in an authentication system, including generating, by an authentication server, virtual data including a virtual code for each object and transmit the virtual data to a safety input apparatus, outputting, by the safety input apparatus, an object selection interface in which each object is placed and a location of each object is changeable, based on the virtual data, generating, by the safety input apparatus, when the location of each object is decided, at least one authentication information including the location information and the virtual code of each object placed in the object selection interface, transmitting, by the safety input apparatus, the at least one generated authentication information to the authentication server, and authenticating, by the authentication server, the user by analyzing the authentication information, and ascertaining whether the virtual code of each secret object set by the user has appointed location information.

In another aspect of the present disclosure, there is provided an authentication apparatus including a storage unit configured to store a plurality of secret objects set by a user, a virtual data providing unit configured to generate a virtual code for each of the plurality of secret objects and a plurality of masquerading objects, and transmit virtual data including the generated virtual code of each object to a communication device of the user, and an authentication unit configured to authenticate the user by receiving authentication information including an arrangement location for each object and the virtual data from the communication device, analyzing the authentication information, and ascertaining whether the virtual code of each secret object has appointed location information.

In another aspect of the present disclosure, there is provided a method which performs security authentication of a user in an authentication system, including selecting, by an authentication server, a plurality of secret objects in an object pool, and transmitting the selected secret objects to a message desination designated by a user, generating, by the authentication server, virtual data including a virtual code for each object and transmitting the virtual data to a safety input apparatus, outputting, by the safety input apparatus, an object selection interface in which each object is placed and a location of each object is changeable, based on the virtual data, generating, by the safety input apparatus, when the location of each object is decided, at least one authentication information including the location information and the virtual code of each object placed in the object selection interface, transmitting, by the safety input apparatus, the at least one generated authentication information to the authentication server, and authenticating, by the authentication server, the user by analyzing the authentication information, and ascertaining whether the virtual code of each selected secret object has appointed location information.

In another aspect of the present disclosure, there is provided an authentication apparatus including a storage unit configured to store an object pool, a secret object providing unit configured to select a plurality of secret objects in the object pool of the storage unit, and transmit the selected secret objects to a message destination designated by a user, a virtual data providing unit configured to select a plurality of masquerading objects in the object pool of the storage unit, generate a virtual code for each of the secret object and the masquerading object, and transmit virtual data including the generated virtual code of each object to a communication device of the user, and an authentication unit configured to authenticate the user by receiving authentication information including an arrangement location for each object and the virtual data from the communication device, analyzing the authentication information, and ascertaining whether the virtual code of each secret object has appointed location information.

In another aspect of the present disclosure, there is provided a safety input apparatus including a storage unit configured to store a plurality of secret objects set by a user, an interface generation unit configured to generate and output a plurality of object selection interfaces in which each object is placed and a location of each object is changeable, and an authentication unit configured to authenticate the user by ascertaining, when the location of each object in the object selection interface is decided, a secret object in each object selection interface, and ascertaining whether each secret object is located at an appointed location.

### Advantageous Effects

The present disclosure authenticates a user based on a location of an object or a secret object combined depending on a location on an object selection interface, and thus, has an advantage of protecting secret data associated with user authentication from an external attack such as shoulder surfing.

Also, the present disclosure generates data associated with an object based on one-time virtual uniform resource locator (URL) and one-time virtual code generated at random each time authentication is required, and authenticates a user based on one-time authentication information generated based on a location of the object placed on an object selection interface, and thus, has an effect of preventing main data of the user from being leaked to a communication network.

Particularly, the present disclosure provides a virtual URL and a virtual code for each object to a user and authenticates the user based on authentication information generated based on the virtual code and the location of the object, and thus, the present disclosure has an advantage of protecting user data more safely because, even if data associated with user authentication is hacked, actually a secret object or an arrangement location of the secret object cannot be known and hacked authentication information is impossible to reuse.

Further, the present disclosure transforms a multi virtual code based on a transformation seed value set by a user, and thus, has an advantage of further improving confidentiality of authentication data of the user. Particularly, when a login password of the user is used as the transformation seed value, the login password is not transmitted to a server, and thus, the present disclosure has a benefit of minimizing the leakage of the user password.

Also, the present disclosure according to another embodiment is designed to fail to proceed with user authentication if location information for each object is not received through a justified device even though a secret object is leaked, because an arrangement location of the secret object changes at random when a user selects a variable arrangement scheme as a secret object arrangement scheme, and thus, may achieve more intensified security.

Moreover, the present disclosure according to another embodiment provides one-time secret object selected at random to a device designated by a user each time authentication is required, and requests the provided one-time secret object to be arranged at an appointed location on an object selection interface, and thus, has a benefit of preventing the reuse of a secret object even if the corresponding secret object is leaked.

Also, the security authentication method according to the present disclosure authenticates a user based on one-time authentication code, and thus, has an effect of replacing a traditional one time password (OTP) authentication method or electronic signature. Particularly, the security authentication method according to the present disclosure produces an effect of electronic signature when an authentication time and an authentication fingerprint (that is, a virtual code of a secret object) are kept after final user authentication.

### DESCRIPTION OF DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawing.

FIG. 1 is a diagram illustrating an authentication system, according to an exemplary embodiment of the present disclosure.

FIG. 2 is a flowchart illustrating a method of registering a secret object of a user in an authentication system, according to an exemplary embodiment of the present disclosure.

FIG. 3 is a diagram illustrating a secret object selection window, according to an exemplary embodiment of the present disclosure.

FIG. 4 is a flowchart illustrating a method of authenticating a user using a multi virtual code in an authentication system, according to an exemplary embodiment of the present disclosure.

FIGS. 5a through 5c are diagrams illustrating various embodiments of an object selection interface, according to the present disclosure.

FIG. 6 is a diagram illustrating a safety input apparatus, according to another exemplary embodiment of the present disclosure.

FIG. 7 is a flowchart illustrating a method of setting a secret object in a safety input apparatus, according to another exemplary embodiment of the present disclosure.

FIG. 8 is a flowchart illustrating a method of authenticating a user in a safety input apparatus, according to another exemplary embodiment of the present disclosure.

FIG. 9 is a diagram illustrating an authentication system, according to still another exemplary embodiment of the present disclosure.

FIG. 10 is a flowchart illustrating a method of registering a user in a security authentication service in an authentication system, according to still another exemplary embodiment of the present disclosure.

FIG. 11 is a flowchart illustrating a method of authenticating a user based on a fixed arrangement scheme in an authentication system, according to still another exemplary embodiment of the present disclosure.

FIG. 12 is a flowchart illustrating a method of authenticating a user based on a user designated arrangement scheme in an authentication system, according to still another exemplary embodiment of the present disclosure.

FIG. 13 is a flowchart illustrating a method of authenticating a user based on a variable arrangement scheme in an authentication system, according to still another exemplary embodiment of the present disclosure.

FIGS. 14a through 14b are diagrams illustrating various embodiment of an object selection interface, according to the present disclosure.

FIGS. 15a and 15b are diagrams illustrating a virtual code recorded in an authentication matrix, according to still another exemplary embodiment of the present disclosure.

FIGS. 16a and 16b are diagrams illustrating an image representing location information for each secret object, according to the present disclosure.

FIG. 17 is a diagram illustrating an authentication system, according to still another exemplary embodiment of the present disclosure.

FIG. 18 is a flowchart illustrating a method of registering a user in a security authentication service in an authentication system, according to still another exemplary embodiment of the present disclosure.

FIG. 19 is a diagram illustrating a location setting window.

FIG. 20 is a flowchart illustrating a method of authenticating a user in an authentication system, according to still another exemplary embodiment of the present disclosure.

FIG. 21 is a diagram illustrating a safety input apparatus applied in a stand-alone environment, according to still another exemplary embodiment of the present disclosure.

### MODE FOR CARRYING OUT THE INVENTION

The foregoing objects, features, and advantages will become apparent from the following detailed description with reference to the accompanying drawings, and accordingly, those skilled in the art will be able to easily practice the technical aspects of the present disclosure. Also, in the description of the present disclosure, when it is deemed that certain detailed description of known technology related to the present disclosure may unnecessarily obscure the essence of the disclosure, its detailed description is omitted herein.

Prior to the description of the present disclosure, the terms used herein will be defined.

The term ‘object’ represents a sort of key information selectable by a user, for example, an image, a sound, a moving image, a text, a number, and the like, and is placed on an object selection interface.

The term ‘secret object’ represents an object set for a security authentication service among a plurality of objects.

The term ‘masquerading object’ represents an object selected to minimize the leakage of the secret object.

The term ‘virtual code’ represents a one-time character string corresponding to the object, and is generated each time authentication is required.

The term ‘multi virtual code’ represents a character string made up of a combination of a plurality of virtual codes.

The term ‘object selection interface’ represents a graphical user interface on which a plurality of objects are placed, and that allows a location movement of an object by manipulation of a user. A secret object and an masquerading object are placed on the object selection interface.

The term ‘virtual uniform resource locator (URL)’ represents a one-time URL of an object, and is generated each time authentication is required, similar to an authentication code.

Hereinafter, exemplary embodiments of the present disclosure will be described in detail with reference to the accompanying drawings.

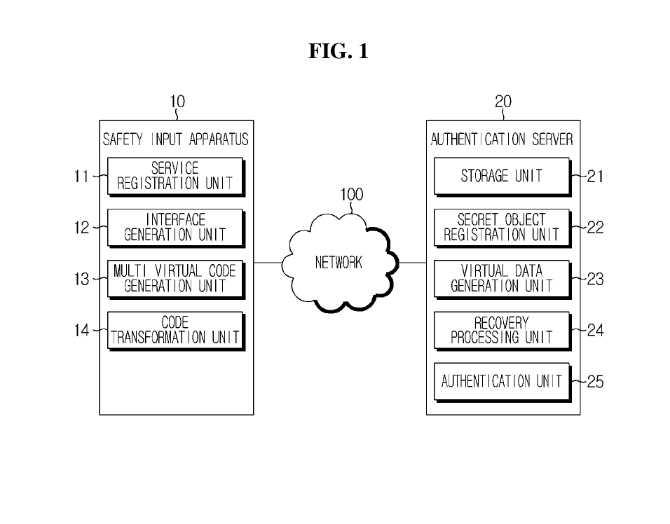

FIG. 1 is a diagram illustrating an authentication system, according to an exemplary embodiment of the present disclosure.

As shown in FIG. 1, the authentication system according to an exemplary embodiment of the present disclosure includes a safety input apparatus 10 and an authentication server 20. The safety input apparatus 10 and the authentication server 20 communicate with each other via a network 100. Here, the network 100 includes a mobile communication network and a wired broadband Internet network, and corresponds to a well-known technology in the present disclosure, and thus, its detailed description is omitted herein.

The safety input apparatus 10 generates authentication information to be protected from hacking such as a sniffing attack and transmits it to the authentication server 20. Also, the safety input apparatus 10 generates and displays a plurality of object selection interfaces using virtual data received from the authentication server 20, the object selection interface on which one secret object and a plurality of masquerading objects are placed and that allows an object movement. Further, when the object movement is completed, the safety input apparatus 10 generates a plurality of multi virtual codes, and transmits the plurality of multi virtual codes to the authentication server 20, to request user authentication to the authentication server 20. The safety input apparatus 10 may be widely applied to a wired/wireless information communication terminal, for example, a laptop computer, a desktop computer, a tablet computer, a mobile communication terminal and other mobile terminals, or electric/electronic devices with a processor and a memory, for example, an automated teller machine (ATM), a door lock, a smart TV, a credit card settlement terminal, and the like.

The safety input apparatus 10 includes a service registration unit 11, an interface generation unit 12, a multi virtual code generation unit 13, and a code transformation unit 14.

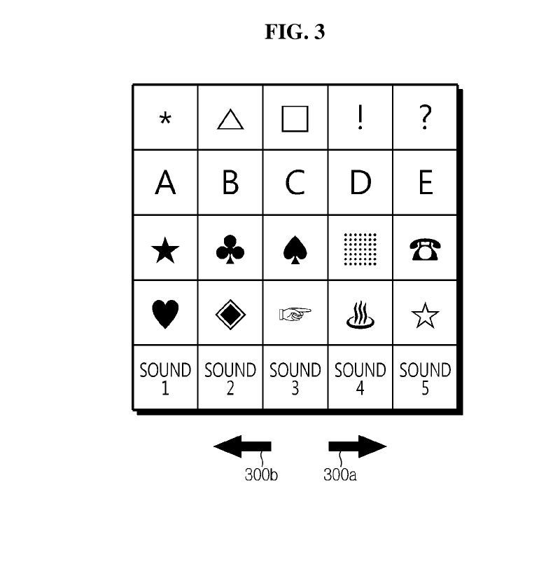

The service registration unit 11 performs a function of registering a security authentication service of a user on the authentication server 20. Specifically, after the user connects to the authentication server 20 and login authentication based on an identification (ID) and a password succeeds, the service registration unit 11 requests the security authentication service registration of the user to the authentication server 20. Also, the service registration unit 11 may receive, from the authentication server 20, a secret object selection window (see FIG. 3), on which a plurality of objects are placed, displays it, and register a plurality of objects inputted through the secret object selection window as a secret object of the user on the authentication server 20. In this instance, the service registration unit 11 sets a secret object for each object selection interface in an order in which the objects are inputted, and registers the secret object set for each object selection interface on the authentication server 20. Also, the service registration unit 11 may register, on the authentication server 20, arrival information (for example, a mobile phone number, an Internet Protocol (IP) address, and the like) of a message receiving device which receives a plurality of one-time secret objects arbitrarily generated by the authentication server 20.

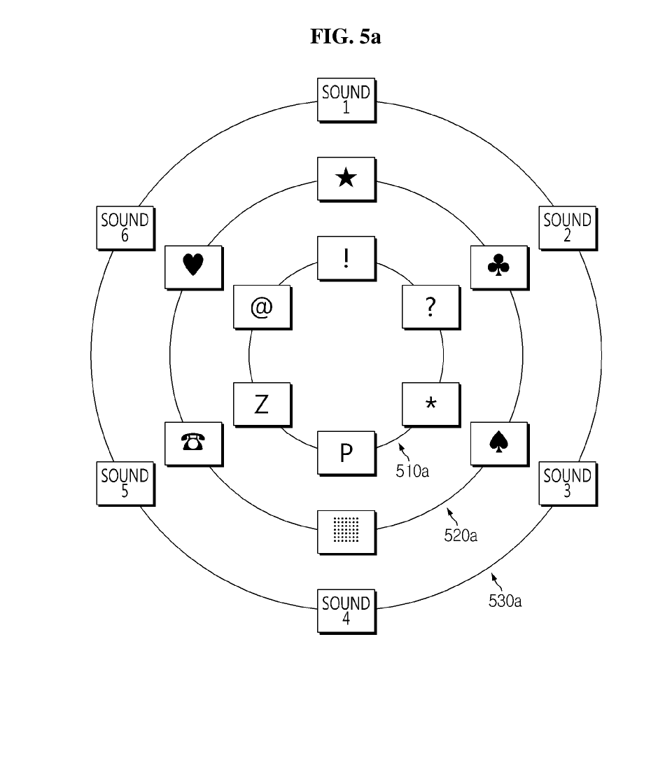

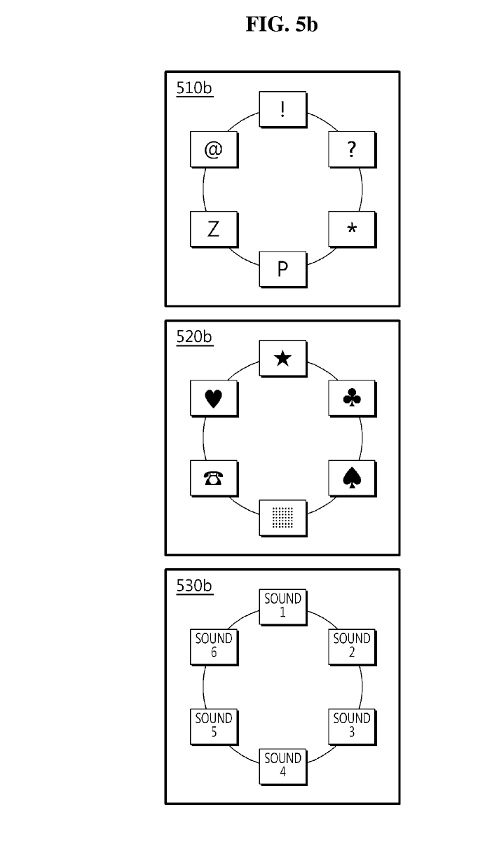

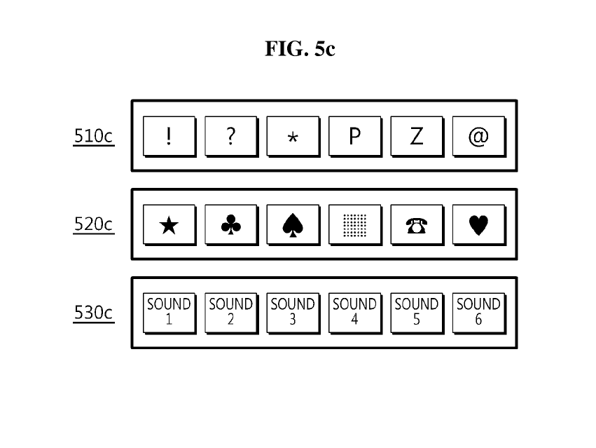

The interface generation unit 12 generates and displays a plurality of object selection interfaces based on the virtual data received from the authentication server 20. That is, when the interface generation unit 12 receives virtual data for each object selection interface from the authentication server 20, the interface generation unit 12 ascertains a virtual URL and a virtual code included in each object selection interface and obtains objects for each object selection interface through each virtual URL. Also, the interface generation unit 12 arranges the obtained objects at an object display location of the corresponding object selection interface, and displays the plurality of object selection interfaces (see FIGS. 5a and 5b) on which the objects are placed. A number of the object selection interfaces may be preset, and may be set in proportion to a number of the secret objects set by the user. The object selection interface may be implemented in various shapes, for example, in a shape of a clock-like circle made up of a plurality of circles in combination or a rectangular grid in length and width. Also, when a particular object placed on the object selection interface moves, a plurality of objects placed in the same line moves together, thereby minimizing the leakage of the secret object to a user close to the user.

In this instance, when a sound URL is recorded in the virtual data, the interface generation unit 12 arbitrarily generates object display information, for example, sound1, sound2, and the like, and places the sound object display information on the object selection interface rather than outputting the sound. In this case, when particular sound object display information is clicked, the interface generation unit 12 obtains an audio corresponding to the sound object through a URL corresponding to the sound object display information and outputs it to a speaker.

Also, when the object is an image, a text, or a number, the interface generation unit 12 may blind the object to avoid displaying the object. In this case, the interface generation unit 12 deblinds the object corresponding to touch coordinates or a location of a mouse pointer and displays it. That is, when a touch signal of the user or a mouse pointer is sensed at a location of the blinded object, the interface generation unit 12 deblinds and displays the corresponding object.

In this instance, the interface generation unit 12 may blind an object movement value of the user. Specifically, when the user inputs an object movement signal through a key movement, a drag and drop, a touch, and the like, the interface generation unit 12 moves the object on the corresponding object selection interface, but does not display the moved object. Additionally, in response to the object movement signal of the user, the interface generation unit 12 updates undisplayed internal object arrangement data and does not display graphic information coming with the object movement on the object selection interface being displayed.

When an object movement complete signal is received from the user, the multi virtual code generation unit 13 performs a function of generating a plurality of multi virtual codes. Specifically, when the object location is decided on each object selection interface, the multi virtual code generation unit 13 determines, as a combination set, objects placed at the same location in each object selection interface, and generates, for each combination set, a multi combination code in which virtual codes of objects included in a same combination set are combined in an order of the object selection interfaces.

The code transformation unit 14 performs a function of data transformation or data encryption. That is, when the multi virtual code generation unit 13 generates the multi virtual code for each group, the code transformation unit 14 transforms the multi virtual code for each group using a transform function to which the seed value set by the user is applied. Preferably, the seed value is preferably a login password of the user. Also, the code transformation unit 14 encrypts the transformed multi virtual code for each group and transmits it to the authentication server 20.

The authentication server 20 is an authentication apparatus for authenticating the user, and performs a function of providing a security authentication service to the user. Particularly, the authentication server 20 stores a plurality of secret objects set by the user, and generates virtual data to prevent the leakage of unique information of the user and provides it to the safety input apparatus 10 of the user. Also, the authentication server 20 receives authentication information including a plurality of multi virtual codes from the safety input apparatus 10, and authenticates the user based on the plurality of multi virtual codes.

The authentication server 20 includes a storage unit 21, a secret object registration unit 22, a virtual data generation unit 23, a recovery processing unit 24, and an authentication unit 25.

The storage unit 21 stores a login ID and a login password of the user, and maps the seed value set by the user to the login ID of the user and stores it. Also, the storage unit 21 may map the secret object for each object selection interface set by the user or the arrival information of the message receiving device of the user to the login ID and store it. Also, the storage unit 21 stores an object pool in which the plurality of objects is registered. Various types of objects such as an image, a moving image, a text, and a sound are registered in the object pool. Also, the storage unit 21 stores a one-time authentication code of the user.

The secret object registration unit 22 receives a plurality of secret objects from the user, and stores the received secret object as a secret object of the user in the storage unit 21. That is, when a request for a security authentication service is received from the safety input apparatus 10, the secret object registration unit 22 transmits a secret object selection window capable of setting a plurality of secret objects to the safety input apparatus 10. Also, the secret object registration unit 22 receives a secret object for each object selection interface selected by the user from the safety input apparatus 10, and maps the received secret object for each object selection interface to the login ID of the user and stores it in the storage unit 21.

As another embodiment, the secret object registration unit 22 may omit the secret object registration of the user, and receive the arrival information of the message receiving device from the user and store it in the storage unit 21. In this case, each time security authentication is performed, the secret object registration unit 22 may arbitrarily select a predetermined number of one-time secret objects, and transmit a secret object notification message including the selected one-time secret objects to the message receiving device (for example, a mobile communication terminal) designated by the user.

The virtual data generation unit 23 performs a function of generating virtual data for each object selection interface. Specifically, the virtual data generation unit 23 ascertains the secret object for each object selection interface mapped to the login ID of the user in the storage unit 21 or a secret object arbitrarily selected by the secret object registration unit 22. Also, the virtual data generation unit 23 selects, for each object selection interface, a predetermined number of masquerading objects that is placed together with each secret object from the object pool of the storage unit 21 to minimize the leakage of the secret objects. In this instance, the virtual data generation unit 23 selects the masquerading objects among the objects except the secret objects. Preferably, the virtual data generation unit 23 ascertains a type of the secret object selected for each object selection interface, and selects a plurality of masquerading objects corresponding to a same type as the type of the secret object for each object selection interface.

Further, the virtual data generation unit 23 generates a virtual URL for each secret object and each masquerading object, and links the generated virtual URL with its corresponding object. Also, after the virtual data generation unit 23 generates a virtual code of each secret object and each masquerading object, the virtual data generation unit 23 generates, for each object selection interface, virtual data in which the generated virtual code and the virtual URL are mapped for each object and provides it to the safety input apparatus 10. Also, the virtual data generation unit 23 ascertains the virtual code of the user for each secret object in the generated virtual code, and stores a multi virtual code, in which the virtual code is combined for each object selection interface, as a one-time authentication code in the storage unit 21.

The recovery processing unit 24 performs a function of decrypting the encrypted data and recovering the transformed data. Specifically, when a plurality of encrypted multi virtual codes is received from the safety input apparatus 10, the recovery processing unit 24 decrypts the plurality of multi virtual codes. Also, the recovery processing unit 24 ascertains the seed value set by the user in the storage unit 21, and recovers the plurality of multi virtual codes using an inverse transform function to which the seed value is applied. Preferably, the seed value may be a login password of the user, and in this case, the recovery processing unit 24 ascertains the login password of the user in the storage unit 21, and recovers the plurality of the multi virtual codes transformed using the inverse transform function to which the login password is applied as the seed value.

The authentication unit 25 not only performs login authentication based on the ID and the password but also performs security authentication of the user based on the plurality of multi virtual codes recovered by the recovery processing unit 24. Particularly, the authentication unit 25 verifies whether there is a virtual code corresponding to the one-time authentication code of the user stored in the storage unit 21 among the plurality of the recovered multi virtual codes, and determines the security authentication of the user as a success when the virtual code is present and determines the security authentication of the user as a failure when the virtual code is absent. Also, when the authentication of the user is completed, the authentication unit 25 deletes the virtual URL, the virtual code, and the one-time authentication code for each object generated by the virtual data generation unit 23.

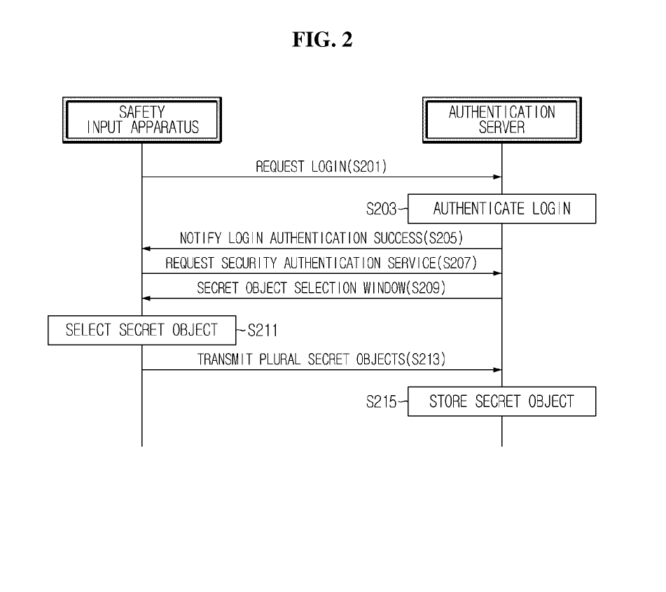

FIG. 2 is a flowchart illustrating a method of registering the secret object of the user in the authentication system, according to an exemplary embodiment of the present disclosure.

Referring to FIG. 2, after the service registration unit 11 connects to the authentication server 20, the service registration unit 11 transmits a login request message including an ID and a password of the user to the authentication server 20 (S201).

Then, the authentication unit 25 of the authentication server 20 performs login authentication of the user by extracting the ID and the password included in the login request message, and ascertaining whether the extracted ID and password are stored in the storage unit 21 as authentication information of the same user (S203). Subsequently, when the login authentication of the user succeeds, the authentication unit 25 of the authentication server 20 transmits a login authentication success notification message to the safety input apparatus 10 (S205).

Subsequently, when the safety input apparatus 10 succeeds the login authentication of the user, the service registration unit 11 receives an input of security authentication service registration from the user. In this case, the service registration unit 11 transmits a security authentication service request message to the authentication server 20 (S207).

Then, the secret object registration unit 22 of the authentication server 20 transmits a secret object selection window capable of setting at least one secret object among the objects registered in the object pool of the storage unit 21 to the safety input apparatus 10 (S209). Subsequently, the service registration unit 11 of the safety input apparatus 10 displays the secret object selection window received from the authentication server 20.

FIG. 3 is a diagram illustrating the secret object selection window, according to an exemplary embodiment of the present disclosure

Referring to FIG. 3, the secret object registration unit 22 of the authentication server 20 transmits, to the safety input apparatus 10, the secret object selection window as shown in FIG. 3 in which a plurality of objects are placed and the user may select a secret object. In this instance, the secret object registration unit 22 may include, in the secret object selection window, direction keys 300a and 300b capable of changing the plurality of objects placed in the secret object selection window. In this case, the secret object registration unit 22 may transmit, to the safety input apparatus 10, the secret object selection window in which some objects (for example, 25 objects) among the objects registered in the object pool of the storage unit 21 are arranged, and when the direction keys 300b and 300b are inputted in the safety input apparatus 10, the secret object registration unit 22 may change the object displayed in secret object selection window by extracting a plurality of another objects from the object pool of the storage unit 21 and transmitting it to the safety input apparatus 10.

Also, the secret object registration unit 22 may include a sound object and audio data of the sound object in the secret object selection window, and in this case, when an output of the sound object is requested from the user, the service registration unit 11 obtains the audio data of the corresponding object and outputs it to a speaker. Preferably, the audio data corresponding to the sound object has a short play time, similar to an effect sound, a cry of an animal, and the like.

Subsequently, the service registration unit 11 of the safety input apparatus 10 sequentially receives, from the user, a selection of a plurality of secret objects among the objects placed in the secret object selection window (S211). Preferably, the user sequentially selects a plurality of objects easy to memorize in the secret object selection window. For example, the user may sequentially select a plurality of animal image objects forming a food chain, or select a plurality of objects giving a particular meaning to the user.

Subsequently, the service registration unit 11 sets a secret object for each object selection interface in an order in which the inputs of the secret objects are received. For example, when a selection of three secret objects is sequentially received from the user, the service registration unit 11 sets a first selected secret object to a first object selection interface, a second selected secret object to a second object selection interface, and a third selected secret object to a third object selection interface, respectively. Subsequently, the service registration unit 11 transmits the plurality of set secret object, that is, the secret objects for each object selection interface to the authentication server 20 (S213).

Then, the secret object registration unit 22 of the authentication server 20 maps the secret object for each object selection interface to the login ID of the user and stores it in the storage unit 21 (S215), completing the secret object registration of the user.

As another embodiment, the secret object registration unit 22 may not receive an input of secret object registration from the safety input apparatus 10 and may receive, from the safety input apparatus 10, arrival information of the message receiving device which receives the secret object. In this case, the secret object registration unit 22 maps the received arrival information of the message receiving device to the login ID of the user and stores it in the storage unit 21.

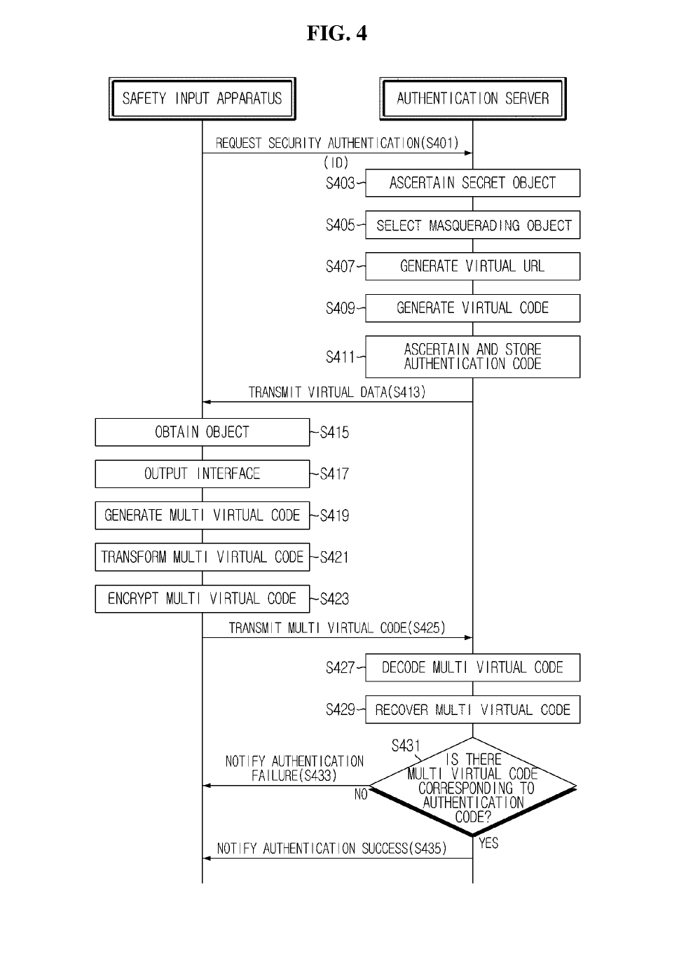

FIG. 4 is a flowchart illustrating a method of authenticating the user using the multi virtual code in the authentication system, according to an exemplary embodiment of the present disclosure.

Referring to FIG. 4, for an intensified security authentication service of the user, the service registration unit 11 of the safety input apparatus 10 transmits a security authentication request message including the login ID of the user to the authentication server 20 (S401).

Then, the virtual data generation unit 23 of the authentication server 20 may ascertain the login ID of the user recorded in the authentication request message, and ascertain the secret object for each object selection interface mapped to the login ID in the storage unit 21 (S403). That is, the virtual data generation unit 23 may ascertain the secret object of the user mapped to the login ID of the user in the storage unit 21.

As still another embodiment, when the secret object mapped to the login ID of the user is not stored in the storage unit 21 and the arrival information of the message receiving device mapped to the login user ID is stored in the storage unit 21, the virtual data generation unit 23 requests a selection of a secret object to the secret object registration unit 22. Then, the secret object registration unit 22 selects a one-time secret object for each object selection interface, and transmits a secret object notification message including the selected one-time secret object to the message receiving device (for example, mobile a communication terminal). When a sound is included in the selected one-time secret object, the secret object registration unit 22 includes a source of the sound or a URL for an access to the sound source in the secret object notification message.

Also, the virtual data providing unit 23 ascertains the one-time secret object for each object selection interface selected by the secret object registration unit 22.

Subsequently, the virtual data generation unit 23 selects a predetermined number of masquerading objects placed for each object selection interface in the object pool of the storage unit 21 (S405). In this instance, the virtual data generation unit 23 selects the masquerading object among the plurality of objects except the secret object. Preferably, the virtual data generation unit 23 ascertains a type of the secret object set for each object selection interface, and selects a plurality of masquerading objects corresponding to a same type as the type of the secret object for each object selection interface. For example, when the secret object of the first object selection interface is an image, the virtual data generation unit 23 extracts a predetermined number of masquerading objects corresponding to the image from the object pool of the storage unit 21, and sets it as a masquerading object of the first object selection interface. As another example, when the secret object set in the third object selection interface is a sound, the virtual data generation unit 23 extracts a predetermined number of masquerading objects corresponding to the sound from the object pool of the storage unit 21, and sets it as a masquerading object of the third object selection interface.

Subsequently, the virtual data generation unit 23 generates a virtual URL for each object for each object selection interface, that is, each secret object and each masquerading object, and links each generated virtual URL with its corresponding object (that is, the masquerading object or the secret object) (S407). Also, the virtual data generation unit 23 generates a virtual code for each object, that is, each secret object and each masquerading object (S409), generates, for each object selection interface, virtual data in which the generated virtual code and virtual URL are mapped for each object. Subsequently, the virtual data generation unit 23 ascertains the virtual code for the secret object in the generated virtual code, and stores a multi virtual code, in which the virtual code is combined in an order of the object selection interfaces, as a one-time authentication code in the storage unit 21 (S411). Subsequently, the virtual data generation unit 23 transmits the virtual data for each object selection interface to the safety input apparatus 10 (S413).

Then, the interface generation unit 12 of the authentication server 20 ascertains the virtual URL and the virtual code for each object in the virtual data for each object selection interface. Also, the interface generation unit 12 obtains objects for each object selection interface through each ascertained virtual URL (S415). Subsequently, the interface generation unit 12 generates a plurality of object selection interfaces by arranging the obtained objects at random at an object display location implemented in the corresponding object selection interface. Subsequently, the interface generation unit 12 displays the plurality of object selection interfaces (S417).

In this instance, when a sound URL is recorded in the virtual data, the interface generation unit 12 arbitrarily generates object display information, for example, sound1, sound2, and the like, and places the sound object display information on the object selection interface rather than outputting the sound. In this case, when particular sound object display information is clicked, the interface generation unit 12 obtains an audio corresponding to the sound object through a URL corresponding to the sound object display information and outputs it to a speaker.

FIGS. 5a through 5c are diagrams illustrating various embodiments of the object selection interface, according to the present disclosure.

Referring to FIGS. 5a through 5c, the interface generation unit 12 generates a plurality of object selection interfaces in which a plurality of objects is placed. In FIGS. 5a and 5b, each object selection interface 510a, 510b, 520a, 520b, 530a, and 530b is formed of a circle, and in FIG. 5c, the object selection interfaces 510c, 520c, and 530c are represented in a rectangular shape. In this instance, the object selection interface according to the present disclosure may be modified and generated in various shapes.

A plurality of object of the same type, for example, a plurality of texts, a plurality of images, a plurality of sounds, and the like, is placed in each of the object selection interfaces. That is, a plurality of objects of a text type is placed in the object selection interface1 510a, 510b, and 510c, a plurality of objects of an image type is placed in the object selection interface2 520a, 520b, and 520c, and a plurality of objects of a sound type is placed in the object selection interface3 530a, 530b, and 530c. Preferably, when a sound URL is recorded in the virtual data, the interface generation unit 12 arbitrarily generates object display information, for example, sound1, sound2, and the like, in the same way as the object selection interface3 530a, 530b, and 530c of FIG. 5, and places the sound object display information in the object selection interface3 530a, 530b, and 530c rather than outputting the sound. In this case, when a particular sound object is clicked in the object selection interface3 530a, 530b, and 530c, the interface generation unit 12 obtains audio data through a URL corresponding to the sound object and outputs it to a speaker.

Also, the location of the object placed in each object selection interface may change by manipulation of the user. That is, the user may change the location of the object placed in each object selection interface through an input means, for example, a mouse, a keyboard, a touch screen, and the like. For example, the user may change the location of each object through a manipulation technique such as object rotation, object drag and drop, and the like. Preferably, a location movement may be made between objects located in the same object selection interface.

In the instance, when the object is an image, a text, or a number, the interface generation unit 12 may blind the object to avoid displaying the object. In this case, the interface generation unit 12 deblinds the object corresponding to touch coordinates or a location of a mouse pointer and displays it. That is, when a touch signal of the user or a mouse pointer is sensed at a location of the blinded object, the interface generation unit 12 deblinds and displays the corresponding object.

As still another embodiment, the interface generation unit 12 may blind an object movement value of the user. That is, when the user inputs an object movement signal through a key movement, a drag and drop, a touch, and the like, the interface generation unit 12 moves the object on the corresponding object selection interface, and may not display the moved object. In other words, in response to the object movement signal of the user, the interface generation unit 12 updates internal object arrangement data, and may not display graphic information representing object movement on the object selection interface.

When the plurality of object selection interfaces are outputted to the safety input apparatus 10, the user adjusts the object location to place the plurality of secret objects sequentially set by the user or place the plurality of one-time secret objects received through the message receiving device in an order at the same location on each object selection interface, and then inputs an object movement complete menu.

For example, in FIG. 5a or 5b, after the user changes the object location for each interface to place the secret objects sequentially set by the user or place the secret objects received through the message receiving device at a location of azimuth 0 degree in an order of the first object selection interface 510a and 510b, the second object selection interface 520a and 520b, and the third object selection interface 530a and 530b, the user inputs an object movement complete menu. As another example, on the object selection interface as shown in FIG. 5c, the user may change the object location to dispose the secret objects sequentially set by the user or the secret objects received through the message receiving device at the left end or the right end in an order of the first object selection interface 510c, the second object selection interface 520c, and the third object selection interface 530c.

When the user decides the object location, the multi virtual code generation unit 13 ascertains the location of each object for which the object location is completed, and sets a plurality of objects placed at the same location on each object selection interface as a combination set. For example, when the object selection interface is as shown in FIG. 5a or 5b, the multi virtual code generation unit 13 sets three object placed at azimuth 0 degree as a first combination set, three objects placed at azimuth 60 degrees as a second combination set, and objects located at azimuth 120 degrees, 180 degrees, 240 degrees, and 300 degrees as a third combination set, a fourth combination set, a fifth combination set, and a sixth combination set, respectively. As another example, when the object selection interface is as shown in FIG. 5c, the multi virtual code generation unit 13 sets, for each object selection interface, three objects placed at the first location from the left as a first combination set, sets three objects placed at the second location from the left as a second combination set, and sets objects placed at the other locations as a separate combination set based on the location.

When the combination set setting is completed, the multi virtual code generation unit 13 generates, for each combination set, a multi combination code in which the virtual codes of the objects included in the corresponding combination set are combined (S419). That is, when the user completes the object movement in the object selection interface, the multi virtual code generation unit 13 sets objects placed at the same location in each object selection interface as a combination set, and generates, for each combination set, a multi combination code in which the virtual code of each object belonging in the same combination set is combined in an order of the object selection interfaces. For example, when the object selection interface in which the object movement is completed is as shown in FIG. 5a, the multi virtual code generation unit 13 sets a plurality of objects (that is, ‘!’, ‘★’, and ‘sound1’) located at azimuth 0 degree as a first combination set. Further, when a virtual code of the ‘!’ object of the first object selection interface 510a is ‘10xie’, a virtual code of the ‘★’ object of the second object selection interface 510b is ‘88txk’, and a virtual code of the ‘sound1’ object of the third object selection interface 510c is ‘kxkZZ’, the multi virtual code generation unit 11 generates ‘10xie88txkkxkZZ’ as a multi virtual code of the first combination set.

Subsequently, the code transformation unit 14 displays a seed value input window for receiving an input of a seed value set by the user, and receives an input of a seed value from the user through the seed value input window. Subsequently, the code transformation unit 14 sets the seed value inputted from the user as a seed of a transform function, and transforms the multi virtual code for each combination set generated by the multi virtual code generation unit 13 through the set transform function (S421). Preferably, the code transformation unit 14 may receive, from the user, an input of a login password of the user as the seed value, and transform the multi virtual code for each combination set using a transform function in which the login password is set as the seed value. Subsequently, the code transformation unit 14 encrypts the transformed multi virtual code for each combination set, and transmits the encrypted multi virtual code for each combination set to the authentication server 20 (S423, S425).

Then, the recovery processing unit 24 of the authentication server 20 decrypts the encrypted multi virtual code for each combination set received from the safety input apparatus 10 (S427). Subsequently, the recovery processing unit 24 ascertains the login ID included in the authentication request message of S401, and extracts the seed value mapped to the login ID from the storage unit 21. Also, the recovery processing unit 24 sets the extracted seed value as a seed of an inverse transform function, and recovers the multi virtual code for each combination set transformed using the inverse transform function in which the seed is set (S429). In this instance, when the login password of the user is set as the seed value, the recovery processing unit 24 may ascertain the login password of the user in the storage unit 21, and recover the transformed multi virtual code for each combination set, using the inverse transform function in which the login password of the user is set as the seed value.

Subsequently, the authentication unit 25 ascertains the virtual code for each combination set recovered by the recovery processing unit 24, and verifies whether there is a virtual code corresponding to the one-time authentication code stored in S411 in the multi virtual code for each combination set (S431).

Subsequently, as a result of the authentication, when a multi virtual code corresponding to the one-time authentication code is absent in the virtual code for each combination set, the authentication unit 25 determines the user authentication for the safety input apparatus 10 as a failure, and transmits an authentication failure notification message to the safety input apparatus 10 (S433).

In contrast, when a multi virtual code corresponding to the one-time authentication code is present in the virtual code for each combination set, the authentication unit 25 determines the user authentication for the safety input apparatus 10 as a success, transmits an authentication success notification message to the safety input apparatus 10 (S435), and provides a service requested from the user.

In this instance, when the user authentication is completed, the authentication unit 25 deletes the virtual URL, the virtual code, and the one-time authentication code for each object generated by the virtual data generation unit 23.

Here, the security authentication method using the object selection interface may be applied in a stand-alone environment with no need for network communication.

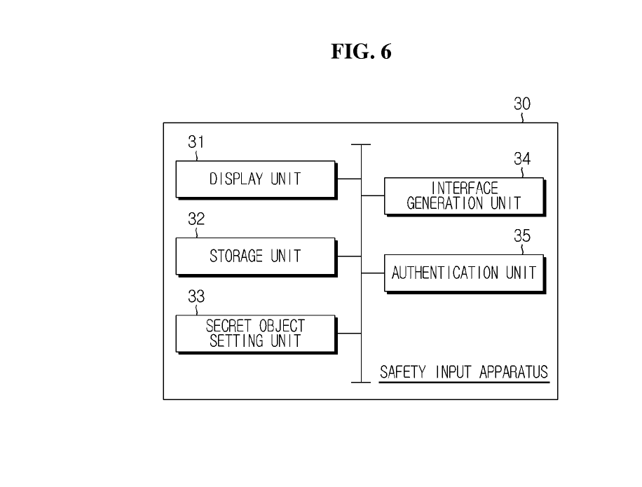

FIG. 6 is a diagram illustrating a safety input apparatus, according to another exemplary embodiment of the present disclosure.

As shown in FIG. 6, the safety input apparatus 30 according to another exemplary embodiment of the present disclosure includes a display unit 31, a storage unit 32, a secret object setting unit 33, an interface generation unit 34, and an authentication unit 35.

The display unit 31 is a display means based on liquid crystal display (LCD) technology, light emitting polymer display (LPD) technology, light emitting diode (LED) technology, and the like, and outputs various information processed by the safety input apparatus 30. Also, the display unit 31 displays a plurality of object selection interfaces. The display unit 31 may be a touch display. In this case, the display unit 31 receives touch information of a user.

The storage unit 32 stores a secret object for each object selection interface set by the user. Also, the storage unit 32 stores an object pool in which a plurality of objects is registered.

The secret object setting unit 33 performs a function of receiving the secret object set for each object selection interface from the user and storing it in the storage unit 32. Specifically, the secret object setting unit 33 outputs, to the display unit 31, a secret object selection window capable of setting at least one secret object among the plurality of objects registered in the IP pool of the storage unit 32, and sequentially receives a selection of a plurality of secret objects from the user through the secret object selection window. Also, the secret object setting unit 33 sets the secret objects for each object selection interface in an order in which the inputs of the secret objects are received, and stores the set secret objects for each object selection interface in the storage unit 32.

The interface generation unit 34 performs a function of generating a plurality of object selection interfaces and outputting it to the display unit 31. That is, after the interface generation unit 34 ascertains the secret objects for each object selection interface in the storage unit 32, the interface generation unit 34 selects, for each object selection interface, a predetermined number of masquerading objects that is placed together with the secret objects in the object selection interface from the object pool of the storage unit 32. Also, the interface generation unit 34 generates a plurality of object selection interfaces in which the corresponding secret object and masquerading object are placed respectively, and outputs it to the display unit 31.

When the object location is decided in the object selection interface, the authentication unit 35 performs user authentication by setting a plurality of objects placed at the same location in each object selection interface as a group, and verifying whether there is a group corresponding to the plurality of secret objects stored in the storage unit 32 among the groups set in this way.

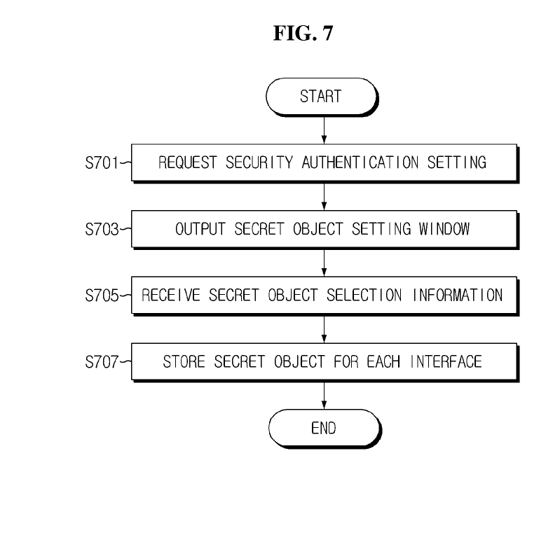

FIG. 7 is a flowchart illustrating a method of setting the secret object in the safety input apparatus, according to another exemplary embodiment of the present disclosure.

Referring to FIG. 7, the safety input apparatus 30 receives a request for security authentication setting from the user (S701). Then, the secret object setting unit 33 of the safety input apparatus 30 outputs, to the display unit 31, a secret object selection window in which the plurality of objects registered in the IP pool of the storage unit 32 are placed (S703). That is, the safety input apparatus 30 outputs the secret object selection window as shown in FIG. 3 to the display unit 31. In this instance, in the case where a sound object is included in the secret object selection window, when a request for playing of the sound object is received from the user, the secret object setting unit 33 extracts an audio of the sound object from the storage unit 32 and outputs it to a speaker.

Subsequently, the secret object setting unit 33 sequentially receives a selection of a plurality of secret objects from the user through the secret object selection window (S705). Then, the secret object setting unit 33 sets the secret objects for each object selection interface in an order in which the user selects the secret objects, and stores the set secret objects for each object selection interface in the storage unit 32 (S707).

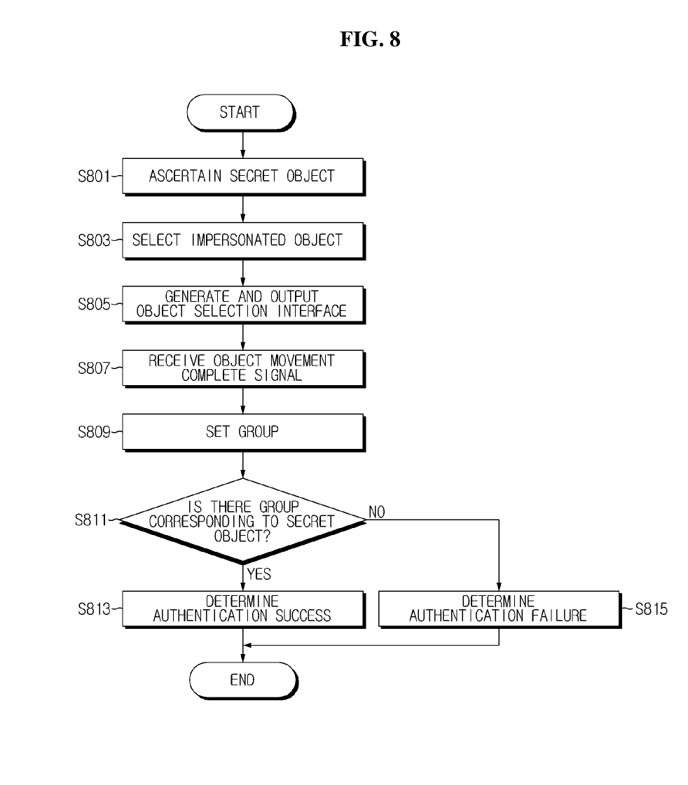

FIG. 8 is a flowchart illustrating a method of authenticating the user in the safety input apparatus, according to another exemplary embodiment of the present disclosure.

Referring to FIG. 8, when the storing of the secret objects of the user is completed, the interface generation unit 34 ascertains the secret objects for each object selection interface stored in the storage unit 32 (S801). Subsequently, the interface generation unit 34 selects a predetermined number of masquerading objects that is placed in each object selection interface from the object pool of the storage unit 32 (S803). In this instance, the interface generation unit 34 selects the masquerading objects among the plurality of objects except the secret objects. Preferably, the interface generation unit 34 ascertains a type of the secret object set in each object selection interface, and selects a plurality of masquerading objects corresponding to a same type as the type of the secret object for each object selection interface.

Subsequently, the interface generation unit 34 generates a plurality of object selection interfaces in which the plurality of selected masquerading objects and each secret object are placed respectively and outputs it to the display unit 31 (S805). That is, the interface generation unit 34 generates the object selection interfaces as shown in FIG. 5a, 5b, or 5c, and outputs them to the display unit 31. In this instance, when a sound is included in the object, the interface generation unit 34 arbitrarily generates display information for the sound, and places the sound object display information on the object selection interface rather than outputting the sound. In this case, when particular sound object display information is clicked, the interface generation unit 34 extracts audio data corresponding to the sound object display information from the storage unit 32 and outputs it to a speaker.

In this instance, when the object is an image, a text, or a number, the interface generation unit 34 may blind the object to avoid displaying the object. In this case, the interface generation unit 34 deblinds the object corresponding to touched coordinates or a location of a mouse pointer and outputs it to the display. That is, when a touch signal of the user or a mouse pointer is sensed at a location of the blinded object, the interface generation unit 34 deblinds and displays the corresponding object.

In this way, when the plurality of object selection interfaces are displayed, the user adjusts the object location to place the plurality of secret objects set by the user in an order at the same location on each object selection interface, and then inputs an object movement complete menu.

Then, the authentication unit 35 receives an object movement complete signal through the object selection interface (S807). Subsequently, the authentication unit 35 ascertains a location of each object in each object selection interface, and sets a plurality of objects placed at the same location as a same group respectively (S809).

Subsequently, the authentication unit 35 verifies whether there is a group corresponding to each secret object for each object selection interface stored in the storage unit 32 among the plurality of groups (S811).

As a result of the authentication, when a group corresponding to the secret objects for each object selection interface stored in the storage unit 32 is present, the authentication unit 35 determines the user authentication as a success (S813), and provides a subsequent service (for example, screen unlocking, folder unlocking, document unlocking, door lock unlocking, and the like) to the user. In contrast, as a result of the authentication of S813, when a group corresponding to the secret object for each object selection interface stored in the storage unit 32 is absent, the authentication unit 35 determines the user authentication as a failure (S815).

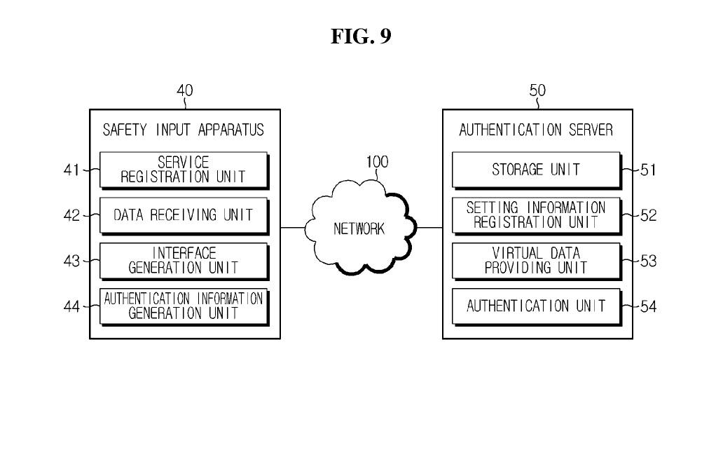

FIG. 9 is a diagram illustrating an authentication system, according to still another exemplary embodiment of the present disclosure.

As shown in FIG. 9, the authentication system according to an exemplary embodiment of the present disclosure includes a safety input apparatus 40 and an authentication server 50.

The safety input apparatus 40 generates and displays an object selection interface in which a plurality of secret objects and a plurality of masquerading objects are placed at random and that allows an object movement, using virtual data received from the authentication server 50. Also, when the arrangement of the objects on the object selection interface is completed, the safety input apparatus 40 requests user authentication to the authentication server 50 by generating authentication information in which a virtual code and location information are recorded for each object arranged on the object selection interface and transmitting it to the authentication server 50. In this instance, the authentication server 50 may generate, as the authentication information, an authentication matrix in which the virtual code for each object is arranged based on location information and transmit it to the authentication server 50.

The safety input apparatus 40 includes a service registration unit 41, a data receiving unit 42, an interface generation unit 43, and an authentication information generation unit 44.

The service registration unit 41 performs a function of registering a security authentication service of the user on the authentication server 50. Specifically, after the user connects to the authentication server 50 and login authentication based on an ID and a password succeeds, the service registration unit 41 requests the security authentication service registration of the user to the authentication server 50. Also, the service registration unit 41 receives, from the authentication server 50, a secret object selection window (see FIG. 3) in which a plurality of objects is placed, displays it, and registers the plurality of objects sequentially inputted through the secret object selection window as a secret object of the user on the authentication server 50. Also, the service registration unit 41 may set any one of a fixed arrangement scheme, a user designated arrangement scheme, and a variable arrangement scheme as a secret object arrangement scheme based on a selection of the user, and registers it in the authentication server 50. When the user selects a user designated arrangement scheme among the secret object arrangement schemes, the service registration unit 41 registers location information for each secret object set by the user on the authentication server 50 by transmitting the location information of each secret object inputted from the user to authentication server 50. Also, when the user selects a variable arrangement scheme, the service registration unit 41 may register, on the authentication server 50, arrival information (for example, a mobile communication terminal phone number) of a message receiving device which receives a message in which the location information for each secret object is recorded.

The data receiving unit 42 receives virtual data including a virtual code and a virtual URL for each object from the authentication server 50.

The interface generation unit 43 generates and displays an object selection interface based on the virtual data received by the data receiving unit 42. That is, the interface generation unit 43 ascertains the virtual URL and the virtual code for each object, and obtains objects through each virtual URL. Also, the interface generation unit 43 places each of the obtained objects at random at an object display location of the object selection interface, and displays the object selection interface (see FIGS. 7a and 7b) in which the objects are placed.

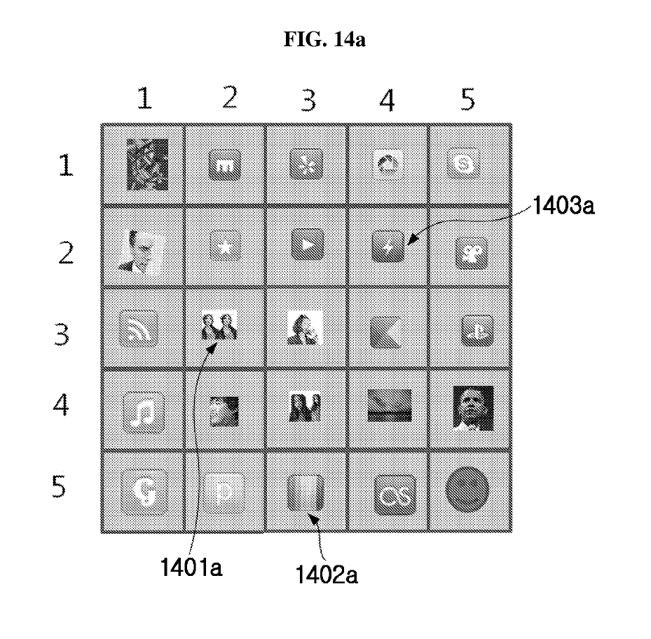

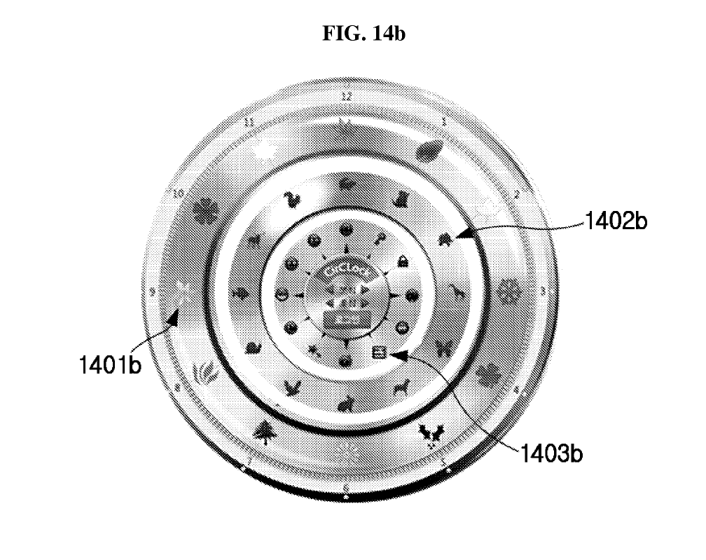

When an input of an object arrangement complete signal is received from the user, the authentication information generation unit 44 requests user authentication by generating, as authentication information of the user, an authentication matrix (see FIGS. 14a and 14b) in which the virtual code for each object is arranged based on the object location and transmitting it to the authentication server 50. That is, when the arrangement of the secret objects in the object selection interface is completed, the authentication information generation unit 44 ascertains the location and the virtual code of each object in the object selection interface, and generates an authentication matrix in which the virtual code of each object is arranged based on the object location. In other words, when the user completes the object arrangement, the authentication information generation unit 44 generates authentication information including the virtual code and location information for each object arranged in the object selection interface and transmits it to the authentication server 50.

In this instance, the authentication information generation unit 44 may transform and encrypt the generated authentication information, that is, the authentication matrix. In this instance, the authentication information generation unit 44 may request user authentication by transforming the authentication matrix using a transform function to which a seed value set by the user is applied, encrypting the transformed authentication matrix, and transmitting it to the authentication server 50. Preferably, the authentication information generation unit 44 sets a login password of the user as the seed value and transforms the authentication matrix.

The authentication server 50 is an authentication apparatus for authenticating the user, and performs a function of providing a security authentication service to the user. Particularly, when the user sets a variable arrangement scheme as the secret object arrangement scheme, the authentication server 50 commands that the secret object is arranged at a designated location by transmitting, to a device designated by the user, a message in which location information for each secret object where the secret object should be located on the object selection interface is recorded. In this instance, the authentication server 50 may transmit the location information for each secret object as a text or an image. Also, when the authentication server 50 receives the authentication matrix from the safety input apparatus 40, the authentication server 50 authenticates the user by analyzing the authentication matrix and ascertaining whether the virtual code of the secret object is arranged at the designated location.

The authentication server 50 includes a storage unit 51, a setting information registration unit 52, a virtual data providing unit 53, and an authentication unit 54.

The storage unit 51 stores a login ID and a login password of the user, and maps the plurality of secret objects, the seed value, and the secret object arrangement scheme (that is, a fixed arrangement scheme, a user designated arrangement scheme, or a variable arrangement scheme) set by the user to the login ID of the user and stores it. In this instance, the storage unit 51 sequentially stores each secret object based on an order of the secret objects set by the user. Also, when the secret object arrangement scheme is a user designated arrangement scheme, the storage unit 51 maps the location information for each secret object set by the user to the login ID of the user and additionally stores it. In this instance, when the secret object arrangement scheme is a variable arrangement scheme, the storage unit 51 maps arrival information (for example, a mobile phone number) of a message receiving device designated by the user to the login ID of the user and additionally stores it. Also, the storage unit 51 stores an object pool in which a plurality of objects is registered.

The setting information registration unit 52 receives a plurality of secret objects from the user, and stores the received secret object as a secret object of the user in the storage unit 51. That is, when the setting information registration unit 52 receives a request for a security authentication service from the safety input apparatus 40, the setting information registration unit 52 transmits a secret object selection window capable of setting a plurality of secret objects to the safety input apparatus 40. Also, the setting information registration unit 52 receives, a plurality of secret objects sequentially selected by the user from the safety input apparatus 40 or, and maps the plurality of secret objects to the login ID of the user and stores it in the storage unit 51. In this instance, the setting information registration unit 52 ascertains an order of the secret objects selected by the user, and stores the secret objects in the storage unit 51 in the order.

Also, the setting information registration unit 52 receives a secret object arrangement scheme of the user from the user, and maps the secret object arrangement scheme to the login ID of the user and stores it in the storage unit 51. In this instance, when the user sets a user designated arrangement scheme as the secret object arrangement scheme, the setting information registration unit 52 receives location information for each secret object from the user, and maps it to the login ID of the user and stores it in the storage unit 51. In this instance, when the user selects a variable arrangement scheme as the secret object arrangement scheme, the setting information registration unit 52 receives arrival information (for example, a mobile phone number) of the message receiving device from the user and maps it to the login ID of the user and stores it in the storage unit 51.

The virtual data providing unit 53 performs a function of providing data necessary for safety login authentication to the safety input apparatus 40. Specifically, the virtual data providing unit 53 ascertains the plurality of secret objects mapped to the login ID of the user and the secret object arrangement scheme in the storage unit 51. Also, the virtual data providing unit 53 selects a predetermined number of masquerading objects that is placed together with each secret object from the object pool of the storage unit 51 respectively to minimize the leakage of the secret objects. In this instance, the virtual data providing unit 53 selects the masquerading objects among the objects except the secret objects. Also, the virtual data providing unit 53 generates a virtual URL for each secret object and each masquerading object, and links the generated virtual URL with its corresponding object. Besides, after the virtual data providing unit 53 generates a virtual code for each secret object and each masquerading object, the virtual data providing unit 53 generates virtual data in which the generated virtual code and the virtual URL are mapped for each object and transmits it to the safety input apparatus 40. Additionally, the virtual data providing unit 53 generates the virtual URL and the virtual code for each object at random each time authentication is required.

In this instance, when the secret object arrangement scheme mapped to the user login ID is set as a variable arrangement scheme, the virtual data providing unit 53 arbitrarily generates location information for each secret object where each secret object should be located on the object selection interface, and transmits a message in which the generated location information for each secret object is recorded to a message receiving device designated by the user (for example, a mobile communication terminal). In this instance, the virtual data providing unit 53 may transmit, to the message receiving device designated by the user, a message in which the location information for each secret object is recorded in text or a message including an image representing the location information for each secret object. Also, the virtual data providing unit 53 may transmit a voice message (that is, an automatic response system (ARS) voice message), in which the location information for each secret object is outputted as a voice, to the message receiving device. In this case, the virtual data providing unit 53 forms a call session to the message receiving device designated by the user, and transmits the voice message notifying the location information for each secret object to the message receiving device.

The authentication unit 54 performs login authentication based on the ID and the password, but also performs user security authentication by ascertaining whether the virtual code corresponding to each secret object is arranged at an appointed location through analysis of the authentication matrix received from the safety input apparatus 40. That is, the authentication unit 54 authenticates the user by ascertaining a location at which the virtual code of each secret object generated by the virtual data providing unit 53 is arranged in the authentication matrix, and based on the ascertained location of the virtual code, determining whether the virtual code of the secret object is arranged at the location designated in the authentication matrix. Also, when the user authentication is completed, the authentication unit 54 deletes the virtual URL, the virtual code, and the location information for each object for each object generated by the virtual data providing unit 53. Also, when the user authentication succeeds, the authentication unit 54 may store an authentication time and the virtual code of the secret object as an authentication fingerprint in the storage unit 51.

In this instance, when the encrypted and transformed authentication matrix is received from the safety input apparatus 40, the authentication unit 54 decrypts the encrypted authentication matrix, ascertains a seed value set by the user in the storage unit 51, and recovers the authentication matrix using an inverse transform function to which the seed value is applied. Preferably, the seed value may be a login password of the user, and the authentication unit 54 ascertains the login password of the user in the storage unit 51, and recovers the authentication matrix using an inverse transform function to which the login password is applied as the seed value.

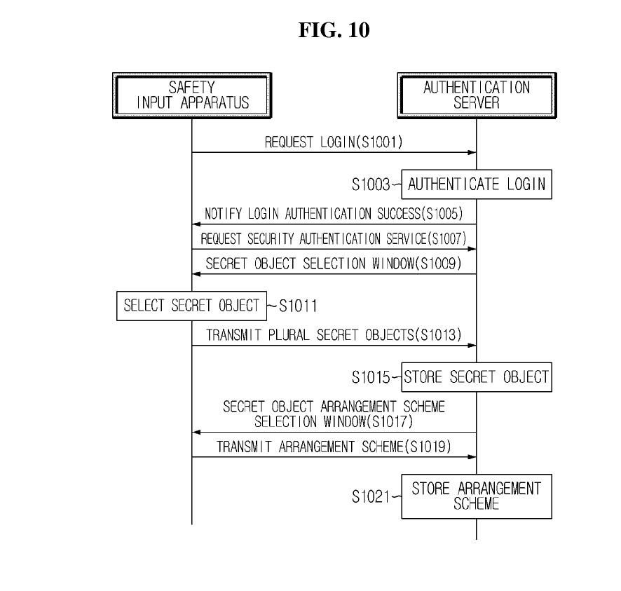

FIG. 10 is a flowchart illustrating a method of registering the user in the security authentication service in the authentication system, according to still another exemplary embodiment of the present disclosure.

Referring to FIG. 10, after the service registration unit 41 of the safety input apparatus 40 connects to the authentication server 50, the service registration unit 41 transmits a login request message including an ID and a password of the user to the authentication server 50 (S1001).

Then, the authentication unit 54 of the authentication server 50 performs user login authentication by extracting the ID and the password included in the login request message and ascertaining whether the extracted ID and password is stored as authentication information of a same user in the storage unit 51 (S1003). Subsequently, when the login authentication of the user succeeds, the authentication unit 54 of the authentication server 50 transmits a login authentication success notification message to the safety input apparatus 40 (S1005).

Subsequently, when the safety input apparatus 40 succeeds the login authentication of the user, the service registration unit 41 may receive an input of security authentication service registration from the user. In this case, the service registration unit 41 transmits a security authentication service request message to the authentication server 50 (S1007).

Then, the setting information registration unit 52 of the authentication server 50 transmits a secret object selection window (see FIG. 3) capable of setting at least one secret object among the objects in the object pool of the storage unit 51 to the safety input apparatus 40 (S1009). Then, the service registration unit 41 of the safety input apparatus 40 displays the secret object selection window received from the authentication server 50.

Subsequently, the service registration unit 41 of the safety input apparatus 40 sequentially receives, from the user, a selection of a plurality of secret objects among the objects placed in the secret object selection window (S1011). Preferably, the user sequentially selects a plurality of objects easy to memorize in the secret object selection window.

Subsequently, the service registration unit 41 sequentially transmits the plurality of secret objects selected by the user through the secret object selection window to the authentication server 50 in an order in which the secret objects are selected (S1013).

Then, the setting information registration unit 52 of the authentication server 50 sequentially receives the plurality of secret objects from the safety input apparatus 40, and maps the plurality of secret objects to the login ID of the user in an order in which the secret objects are received and stores it in the storage unit 51 (S1015), completing the secret object registration of the user.

Subsequently, the setting information registration unit 52 transmits, to the safety input apparatus 40, a secret object arrangement scheme selection window requesting a selection of any one of a fixed arrangement scheme, a user designated arrangement scheme, and a variable arrangement scheme as a secret object arrangement scheme (S1017).

Then, the service registration unit 41 of the safety input apparatus 40 displays the secret object arrangement scheme selection window, and receives an input of any one of a fixed arrangement scheme, a user designated arrangement scheme, and a variable arrangement scheme from the user. In this instance, when the user selects a user designated arrangement scheme, the service registration unit 41 receives, from the user, an input of location information for each secret object set by the user. Also, when the user selects a variable arrangement scheme, the service registration unit 41 receives, from the user, an input of arrival information (for example, a mobile communication terminal phone number, an IP address, and the like) of a message receiving device in which location information for each secret object is received.

Subsequently, the safety input apparatus 40 transmits the secret object arrangement scheme selected by the user to the authentication server 50 (S1019). In this instance, when the user selects a user designated arrangement scheme, the safety input apparatus 40 additionally transmits location information for each secret object of the user to the authentication server 50, and when the user selects a variable arrangement scheme, additionally transmits the arrival information of the message receiving device to the authentication server 50.

Then, the setting information registration unit 52 of the authentication server 50 maps the secret object arrangement scheme received from the safety input apparatus 40 to the login ID of the user and stores it in the storage unit 51 (S1021). In this instance, when the user sets a user designated arrangement scheme as the secret object arrangement scheme and the location information of each secret object is received from the safety input apparatus 40, the setting information registration unit 52 maps the location information for each secret object to the login ID of the user and additionally stores it in the storage unit 51. Also, when the user sets a variable arrangement scheme as the secret object arrangement scheme and the arrival information of the message receiving device is received from the safety input apparatus 40, the setting information registration unit 52 maps the arrival information of the message receiving device to the login ID of the user and additionally stores it in the storage unit 51.

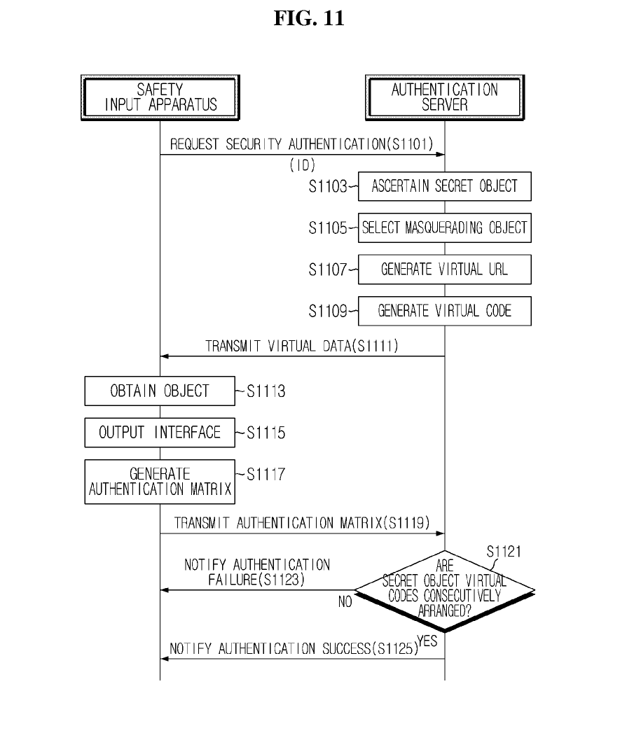

Hereinafter, through the description with reference to FIGS. 11 through 16, an authentication method based on a fixed arrangement scheme, a user designated arrangement scheme, and a variable arrangement scheme is described.

FIG. 11 is a flowchart illustrating a method of authenticating the user based on a fixed arrangement scheme in the authentication system, according to still another exemplary embodiment of the present disclosure

In the description with reference to FIG. 11, the description is made based on that the user sets a fixed arrangement scheme as the secret object arrangement scheme and registers it in the authentication server 50.

Referring to FIG. 11, for an intensified security authentication service of the user, the safety input apparatus 40 transmits a security authentication request message including a login ID of the user to the authentication server 50 (S1101).

Then, the virtual data providing unit 53 of the authentication server 50 ascertains the login ID of the user recorded in the authentication request message, and ascertains a plurality of secret objects mapped to the login ID and a secret object arrangement scheme in the storage unit 51 (S1103). That is, the virtual data providing unit 53 ascertains the plurality of secret objects sequentially set by the user in the storage unit 51, and ascertains the secret object arrangement scheme set by the user in the storage unit 51. In the description with reference to FIG. 11, the virtual data providing unit 53 ascertains that the secret object arrangement scheme set by the user is a fixed arrangement scheme in the storage unit 51.

Subsequently, the virtual data providing unit 53 selects a predetermined number of masquerading objects that is placed in the object selection interface from the object pool of the storage unit 51 (S1105). In this instance, the virtual data providing unit 53 selects the masquerading objects among the plurality of objects except the secret objects.

Subsequently, the virtual data providing unit 53 generates a virtual URL for each secret object and each masquerading object, and links each generated virtual URL with its corresponding object (that is, the masquerading object or the secret object) (S1107). Accordingly, the safety input apparatus 40 connects to the virtual URL to obtain each object lined with each URL.

Also, the virtual data providing unit 53 arbitrarily generates a one-time virtual code for each object, that is, each secret object and each masquerading object (S1109). Subsequently, the virtual data providing unit 53 transmits virtual data in which the virtual URL and the virtual code are mapped for each object to the safety input apparatus 40 (S1111).

Then, the interface generation unit 43 of the safety input apparatus 40 ascertains the virtual URL and the virtual code in the received virtual data. Also, the interface generation unit 43 gets access to each ascertained virtual URL and obtains each object (S1113). Subsequently, the interface generation unit 43 places the obtained objects at random at an object display location implemented in the object selection interface, completing the generation of the object selection interface. Subsequently, the interface generation unit 43 outputs the plurality of generated object selection interfaces to the display (S1115).

FIGS. 14a through 14b are diagrams illustrating various embodiment of the object selection interface, according to the present disclosure.

Referring to FIGS. 14a and 14b, the interface generation unit 43 generates an object selection interface in which a plurality of objects is placed. FIG. 14a shows that each object is placed in a grid-type object selection interface, and FIG. 14b shows a circle-type object selection interface including a combination of three circles. In this instance, the object selection interface according to the present disclosure may be modified and generated in various shapes.

Also, the location of the object placed in each object selection interface may change by manipulation of the user. That is, the user may change the location of object placed in the object selection interface through an input means, for example, a mouse, a keyboard, a touch screen, and the like. Preferably, when a particular object moves in the object selection interface, a plurality of objects placed in the same line as the object moves together, to minimize the leakage of the secret object to a user close to the user. In FIG. 14a, when an object having reference number 1401a moves one block to the right, other objects located in the third row move one block to the right together. Also, in FIG. 14b, when an object having reference numeral 1401b placed at the outermost circle moves in a clockwise direction, other objects placed at the outermost circle also rotate in the clockwise direction.

When the object selection interface is outputted to the safety input apparatus 40 in this way, the user moves at least one object to place a secret object at an appointed location in accordance with a fixed arrangement scheme. That is, after the user moves the object in the object selection interface to arrange secret objects of the user in a consecutive manner, the user inputs an arrangement complete menu.

For example, in FIG. 14a, when each of the objects 1401a, 1402a, and 1403a is a secret object set by the user, the user may change at least one object location to sequentially place the secret objects in a row or column in a consecutive manner. That is, to consecutively place the other secret objects from the XY coordinates (2,3) of 1401a in the object selection interface of FIG. 14a, the user moves the object 1402a to the coordinates (3,3) and the object 1403a to the coordinates (4,3). Also, in FIG. 14b, when each of the objects 1401b, 1402b, and 1403b is a secret object set by the user, the user may change the location of the object to place the secret objects 1401b, 1402b, and 1403b at a same azimuth location. That is, the user may change the location of the object to place the secret objects 1401b, 1402b, and 1403b set by the user in a line indicating a same number in the object selection interface of FIG. 14b.

After the user arranges the secret objects at an appointed location, the user inputs an object arrangement complete menu in the safety input apparatus 40. Then, the authentication information generation unit 44 of the safety input apparatus 40 generates an authentication matrix in which a virtual code for each object is arranged based on location information (S1117). Specifically, the safety input apparatus 40 ascertains each object placed in the object selection interface in which arrangement is completed, and generates the authentication matrix in which the object and its corresponding virtual code are arranged based on the location for each object.

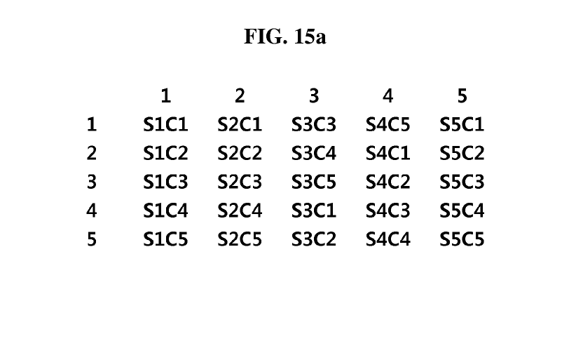

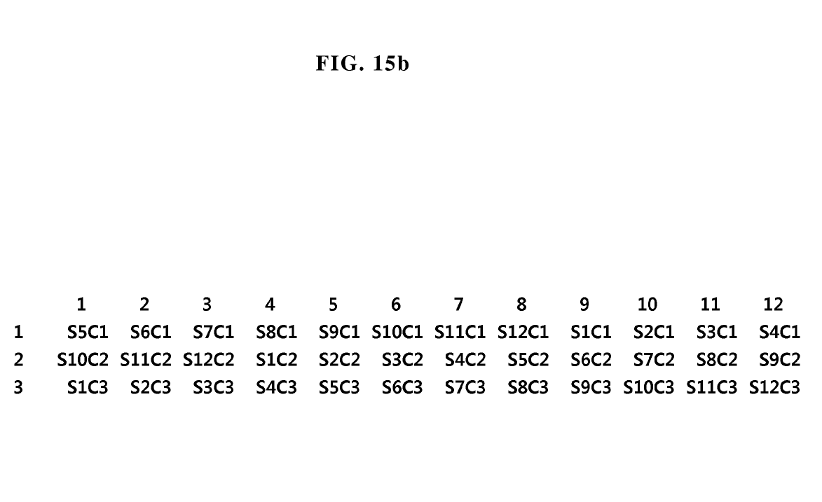

FIGS. 15a and 15b are diagrams illustrating the virtual code recorded in the authentication matrix, according to still another exemplary embodiment of the present disclosure.

Describing with illustration in FIGS. 15a and 15b, the authentication information generation unit 44 ascertains the object placed at the XY coordinates in the interface of FIG. 14a, and generates the authentication matrix in which the virtual code corresponding to the object is arranged based on location information. In FIG. 14a, the objects 1401a, 1402a, and 1403a correspond to virtual codes “S2C3”, “S35C”, and “S4C2” in FIG. 15a, respectively. That is, when the user arranges the secret objects at the coordinates (2,3) (3,3), and (4,3) in a consecutive manner, the virtual codes for the secret objects are recorded in the third row of the authentication matrix in a consecutive manner as shown in FIG. 15a.

Also, the objects 1401b, 1402b, and 1403b in FIG. 14b correspond to virtual codes “S9C1”, “S2C2”, and “S5C3” in FIG. 15b, respectively. That is, when the user arranges each secret object 1401b, 1402b, and 1403b in a direction of five o'clock azimuth in the object selection interface of FIG. 14b, the virtual codes for the secret objects are recorded in a fifth row of the authentication matrix in a consecutive manner as shown in FIG. 8b.

Subsequently, the authentication information generation unit 44 transmits the generated authentication matrix to the authentication server 50 (S1119). In this instance, the authentication information generation unit 44 may receive an input of a seed value from the user, and transform each virtual code recorded in the authentication matrix using a transform function to which the seed value is applied. Preferably, the authentication information generation unit 44 receives an input of a login password of the user as the seed value, and transforms the virtual code recorded in the authentication matrix using a transform function to which the login password is applied as the seed value.

Subsequently, the authentication unit 54 of the authentication server 50 performs user authentication by analyzing the authentication matrix received from the safety input apparatus 40. Specifically, the authentication unit 54 authenticates the user by ascertaining the virtual codes for each secret object generated by the virtual data providing unit 53, and ascertaining whether the virtual codes of the secret objects are arranged in the authentication matrix in a consecutive manner (S1121). That is, the authentication unit 54 authenticates the user by ascertaining whether the virtual codes for each secret object are arranged in a row or column of the authentication matrix in a consecutive manner as the user of the safety input apparatus 40 sets a fixed arrangement scheme as the secret object arrangement scheme. In this instance, when the authentication matrix is transformed, the authentication unit 54 may extract a seed value of the user from the storage unit 51, and recover each virtual code of the transformed authentication matrix using an inverse transform function to which the extracted seed value is applied. When the seed value is a login password of the user, the authentication unit 54 extracts the login password of the user from the storage unit 51, and applies the extracted login password as the seed value of the inverse transform function.

Subsequently, when the virtual codes for each secret object of the user are not arranged in the authentication matrix in a consecutive manner, the authentication unit 54 determines the user authentication for the safety input apparatus 40 as a failure, and transmits an authentication failure notification message to the safety input apparatus 40 (S1123).

In contrast, when the virtual codes for each secret object of the user are arranged in a row or column of the authentication matrix in a consecutive manner user, the authentication unit 54 determines the user authentication for the safety input apparatus 40 as a success, and transmits an authentication success notification message to the safety input apparatus 40 (S1125), and provides a service requested from the user. In this instance, when the user authentication is completed, the authentication unit 54 deletes the virtual URL and the virtual code for each object generated by the virtual data providing unit 53.

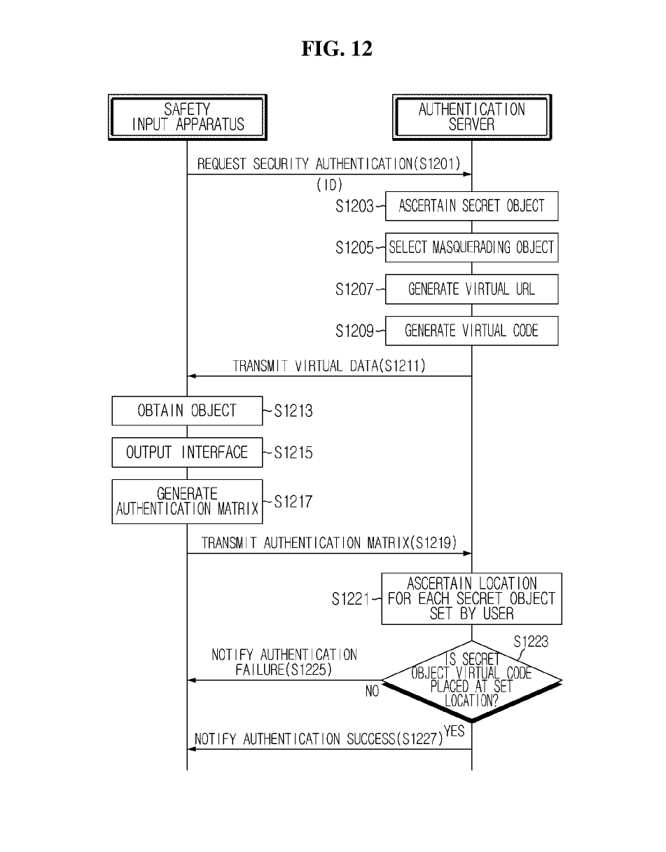

FIG. 12 is a flowchart illustrating a method of authenticating the user based on the user designated arrangement scheme in the authentication system, according to still another exemplary embodiment of the present disclosure.

In the description with reference to FIG. 12, the description is made based on that the user sets a user designated arrangement scheme as a secret object arrangement scheme, and presets location information for each secret object on the authentication server 50. Also, in the description with reference to FIG. 12, an overlapping description with FIG. 11 is abridged and briefly provided.

Referring to FIG. 12, the safety input apparatus 40 transmits a security authentication request message including a login ID of the user to the authentication server 50 (S1201).

Then, the virtual data providing unit 53 of the authentication server 50 ascertains the login ID of the user recorded in the authentication request message, and ascertains a plurality of secret objects mapped to the login ID and a secret object arrangement scheme in the storage unit 51 (S1203). In the description with reference to FIG. 12, the virtual data providing unit 53 ascertains that the secret object arrangement scheme set by the user is a user designated arrangement scheme in the storage unit 51, and ascertains location information for each secret object set by the user in the storage unit 51.

Subsequently, the virtual data providing unit 53 selects a predetermined number of masquerading objects from the object pool of the storage unit 51 (S1205). Subsequently, the virtual data providing unit 53 generates a virtual URL for each secret object and each masquerading object, and links each generated virtual URL with its corresponding object (S1207). Also, the virtual data providing unit 53 generates a virtual code for each object (S1209), and transmits virtual data in which the virtual URL and the virtual code are mapped for each object to the safety input apparatus 40 (S1211).

Then, the interface generation unit 43 of the safety input apparatus 40 obtains objects through the virtual URL included in the virtual data (S1213), places the obtained objects in an object selection interface at random, and displays the object selection interface in which the objects are placed (S1215).

When the object selection interface is outputted to the safety input apparatus 40, the user moves each secret object to a location of the secret object set by the user on the object selection interface. That is, the user pre-registers, on the authentication server 50, location information for each secret object where each secret object should be located, moves each secret object on the object selection interface while recognizing the registered location information for each secret object, and inputs an arrangement complete menu.

For example, in FIG. 14a, when each of the objects 1401a, 1402a, and 1403a is a secret object set by the user and secret object location information of 1401a, 1402a, and 1403a is (2,2), (3,4), and (4,3), respectively, after the user moves the secret object 1401a to the coordinates (2,2), moves the secret object 1402a to the coordinates (3,4), and moves the secret object 1403a to the coordinates (4,3), the user may input an object arrangement complete menu. Also, in FIG. 14b, when each of the objects 1401b, 1402b, and 1403b is a secret object set by the user and an azimuth of each of 1401b, 1402b, and 1403b is 360 degrees, 30 degrees, and 180 degrees, after the user moves the secret object 1401b in a direction of twelve o'clock, moves the secret object 1402b in a direction of one o'clock, and moves the secret object 1403b in a direction of six o'clock, the user inputs an object arrangement complete menu.

Subsequently, the authentication information generation unit 44 of the safety input apparatus 40 generates an authentication matrix in which the virtual code for each object is arranged based on location information (S1217). That is, the safety input apparatus 40 ascertains each object placed in the arrangement completed object selection interface, and generates an authentication matrix as shown in FIG. 15 in which the virtual code corresponding to the object is arranged based on the location for each object. Subsequently, the authentication information generation unit 44 transmits the generated authentication matrix to the authentication server 50 (S1219).

Then, the authentication unit 54 of the authentication server 50 ascertains the virtual code for each secret object generated by the virtual data providing unit 53, and ascertains the location information for each secret object set by the user (S1221). Subsequently, the authentication unit 54 authenticates the user by ascertaining each virtual code representing the secret object in the authentication matrix based on the ascertained virtual code for each secret object, and determining whether a location of each ascertained virtual code matches the location information of each secret object set by the user (S1223). That is, the authentication unit 54 verifies whether the virtual code representing the secret object is arranged at the location set by the user in the authentication matrix.

Subsequently, when any one of the virtual codes of the secret objects is not arranged at the location preset by the user, the authentication unit 54 determines the user authentication for the safety input apparatus 40 as a failure, and transmits an authentication failure notification message to the safety input apparatus 40 (S1225).

In contrast, when the virtual code for each secret object is arranged at the location preset by the user in the authentication matrix, the authentication unit 54 determines the user authentication for the safety input apparatus 40 as a success, transmits an authentication success notification message to the safety input apparatus 40 (S1227), and provides a service requested from the user. Also, when the user authentication is completed, the authentication unit 54 deletes the virtual URL and the virtual code for each object generated by the virtual data providing unit 53.

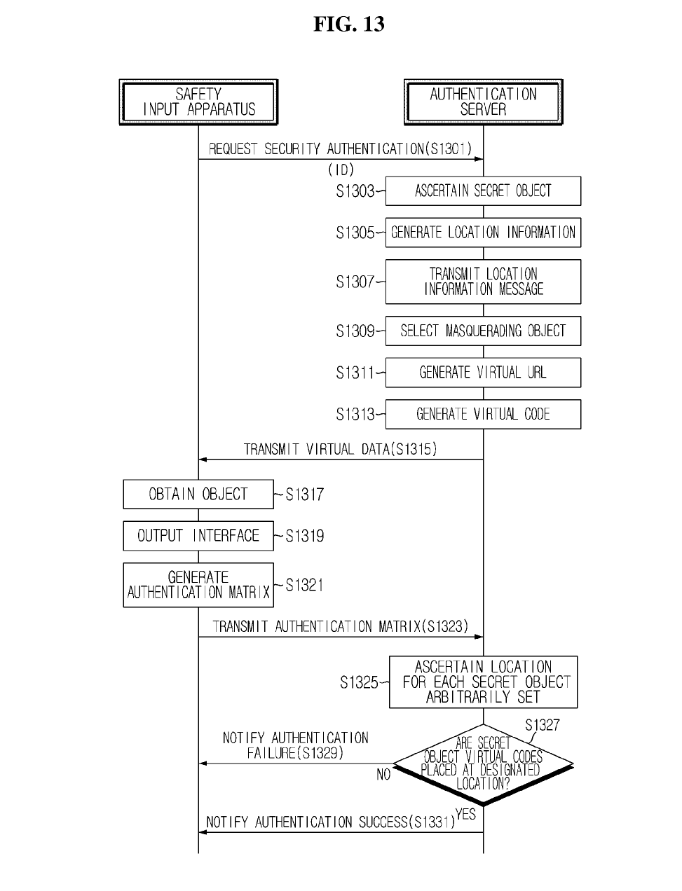

FIG. 13 is a flowchart illustrating a method of authenticating the user based on a variable arrangement scheme in the authentication system, according to still another exemplary embodiment of the present disclosure.

In the description with reference to FIG. 13, the description is made based on that the user sets a variable arrangement scheme as a secret object arrangement scheme and registers it on the authentication server 50.

Referring to FIG. 13, for an intensified security authentication service of the user, the safety input apparatus 40 transmits a security authentication request message including a login ID of the user to the authentication server 50 (S1301).

Then, the virtual data providing unit 53 of the authentication server 50 ascertains the login ID of the user recorded in the authentication request message, and ascertains a plurality of secret objects mapped to the login ID and a secret object arrangement scheme in the storage unit 51 (S1303). In the description with reference to FIG. 13, the virtual data providing unit 53 ascertains a variable arrangement scheme as the secret object arrangement scheme set by the user in the storage unit 51, and ascertains arrival information (for example, a mobile communication phone number, an IP address, and the like) of a message receiving device designated as a message destination by the user in the storage unit 51.

Subsequently, as the secret object arrangement scheme set by the user is a variable arrangement scheme, the virtual data providing unit 53 arbitrarily generates location information for each secret object where each ascertained secret object should be located on the object selection interface (S1305). Subsequently, the virtual data providing unit 53 records the generated location information for secret object in a message, and transmits the message to the message receiving device set as the message destination by the user (S1307). That is, the virtual data providing unit 53 ascertains the arrival information of the message to the message receiving device designated as the message destination by the user, sets the arrival information as a destination, and transmits the message in which the generated location information for each secret object is recorded. The virtual data providing unit 53 may transmit a message in which the location information for each secret object is recorded in text or a message including an image representing the location information for each secret object to the message receiving device designated by the user. Optionally, the virtual data providing unit 53 may transmit a voice message (that is, an ARS voice message), in which the location information for each secret object is outputted as a voice, to the message receiving device. In this case, after the virtual data providing unit 53 forms a call session to the message receiving device designated by the user, the virtual data providing unit 53 transmits the voice message representing the location information for each secret object to the message receiving device. Accordingly, the user recognizes the location at which each secret object set by the user should be located on the object selection interface, through the message received via the message receiving device.

For the location information for each object, for example, when three secret objects are set by the user and the object selection interface is of a grid type as shown in FIG. 14a, the virtual data providing unit 53 may transmit a message in which a text “322444” representing the XY axis coordinates is recorded as location information for each secret object to the message receiving device. Here, “322444” represents that the coordinates of the first secret object are (3,2), the coordinates of the second secret object are (2,4), and the coordinates of the third secret object are (4,4). As another example, when three secret objects are set by the user and the object selection interface is of a circle type in which three circles are combined (see FIG. 14b), the virtual data providing unit 53 may transmit a message in which a text “113520” representing hr/min/sec is recorded as location information for each secret object to the message receiving device. Here, the “113520” represents azimuth coordinates when the first secret object is located with the hour hand pointing at eleven o'clock, azimuth coordinates when second secret object is located with the minute hand pointing at thirty five minutes, and azimuth coordinates when the third secret object is located with the second hand pointing at twenty seconds.

In this instance, to protect the location information for each secret object from external hacking, it is preferred to transmit a message including an image displaying the location information for each secret object to the message receiving device.

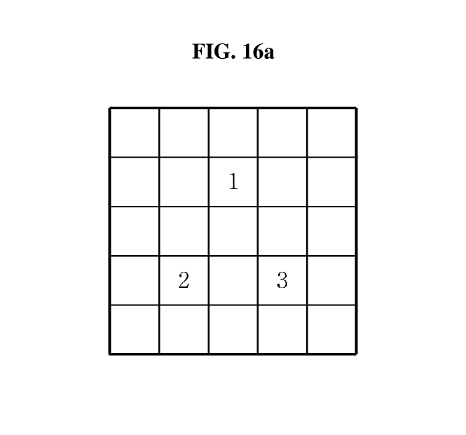

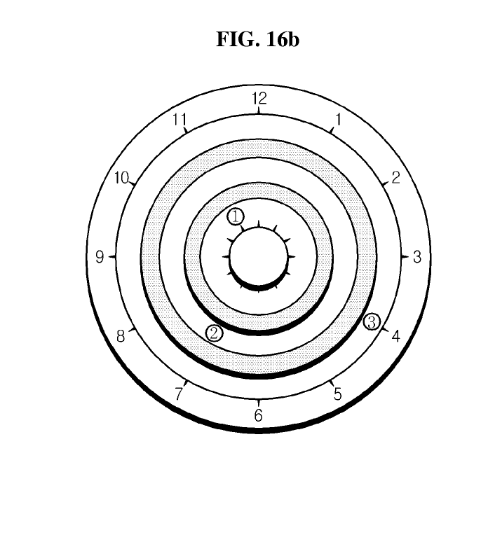

FIGS. 16a and 16b are diagrams illustrating the image representing the location information for each secret object, according to the present disclosure.

Referring to FIGS. 16a and 16b, the virtual data providing unit 53 may generate an image representing location information for each secret object, and transmit a message including the image to a message receiving device designated by the user. FIG. 16a shows an image form representing location information where each secret object should be located in a grid-type object selection interface. That is, according to FIG. 16a, the first secret object set by the user should be located at the coordinates (3,2), the second secret object should be located at the coordinates (2,4), and the third secret object should be located at the coordinates (4,4). Also, FIG. 16b shows an image form representing location information where each secret object should be located in a circle-type object selection interface made up of three circles in combination. That is, according to FIG. 16b, the first secret object set by the user should be located at azimuth coordinates when the hour hand is at eleven o'clock, the second secret object should be located at azimuth coordinates when the minute hand is at thirty five minutes, and the third secret object should be located at azimuth coordinates when the second hand is at twenty seconds.

Referring to FIG. 13 again, the virtual data providing unit 53 selects a predetermined of masquerading objects that is placed in the object selection interface from the object pool of the storage unit 51 (S1309). Subsequently, the virtual data providing unit 53 generates a virtual URL for each secret object and each masquerading object, and links each generated virtual URL with its corresponding object (that is, the masquerading object or the secret object) (S1311).

Also, the virtual data providing unit 53 generates a virtual code for each object, that is, each secret object and each masquerading object (S1313), and transmits virtual data in which the virtual URLs and the virtual codes are mapped for each object to the safety input apparatus 40 (S1315).

Then, the interface generation unit 43 of the safety input apparatus 40 ascertains the virtual URL and the virtual code for each object in the received virtual data, and gets access to each virtual URL and obtains each object (S1317). Subsequently, the interface generation unit 43 generates and displays an object selection interface by placing the obtained objects at random at an object display location implemented in the object selection interface (S1319).

When the object selection interface is outputted to the safety input apparatus 40 in this way, the user moves each secret object to a designated location based on the location information for each secret object recorded in the message received from the authentication server 50. That is, the user ascertains the location information for each secret object received from the authentication server 50 through the message receiving device, moves each secret object on the object selection interface while recognizing the ascertained location information for each secret object, and inputs an arrangement complete menu.

For example, in FIG. 14a, when each of the objects 1401a, 1402a, and 1403a is a secret object set by the user and secret object location information of 1401a, 1402a, and 1403a received from the authentication server 50 is (3,2), (2,4), and (4,4), respectively, after the user moves the secret object 1401a to the coordinates (3,2), the secret object 1402a to the coordinates (2,4), and the secret object 1403a to the coordinates (4,4), the user may input an object arrangement complete menu. Also, in FIG. 14b, when each of the objects 1401b, 1402b, 1403b is a secret object set by the user and the secret object location information received from the authentication server 50 is a text “113520” representing 11 hr 35 min 20 sec or an image as shown in FIG. 16b, the user moves the secret object 1401b in a direction of eleven o'clock, the secret object 1402b in a direction of seven o'clock, and the secret object 1403b in a direction of four o'clock, and inputs an object arrangement complete menu.

Subsequently, the authentication information generation unit 44 of the safety input apparatus 40 generates an authentication matrix in which the virtual code for each object is arranged based on the location information (S1321). That is, the authentication information generation unit 44 ascertains each object placed in the arrangement completed object selection interface, and generates an authentication matrix as shown in FIG. 15 in which the virtual code corresponding to the object is arranged based on the location for each object.

Subsequently, the authentication information generation unit 44 transmits the generated authentication matrix to the authentication server 50 (S1323). Then, the authentication unit 54 of the authentication server 50 ascertains the virtual code for each secret object generated by the virtual data providing unit 53, and ascertains the location information of each secret object arbitrarily generated by the virtual data providing unit 53 (S1325). Subsequently, the authentication unit 54 authenticates the user by verifying, for each secret object, whether the virtual code of the corresponding secret object is correctly arranged in the authentication matrix based on the arbitrarily generated location of each secret object (S1327). That is, the authentication unit 54 authenticates the user by ascertaining each virtual code representing the secret object in the authentication matrix based on the ascertained virtual code for each secret object, and ascertaining whether the ascertained location for each virtual code matches the location information for each secret object arbitrarily generated by the virtual data providing unit 53.

Subsequently, when any one of the virtual codes of the secret objects is not arranged at a designated location, the authentication unit 54 determines the user authentication for the safety input apparatus 40 as a failure, and transmits an authentication failure notification message to the safety input apparatus 40 (S1329).

In contrast, when the virtual code for each secret object is arranged at a location preset by the user in the authentication matrix, the authentication unit 54 determines the user authentication for the safety input apparatus 40 as a success, transmits an authentication success notification message to the safety input apparatus 40 (S1331), and provides a service requested from the user. Also, when the user authentication is completed, the authentication unit 54 deletes the virtual URL, the virtual code, and the location information for each object generated by the virtual data providing unit 53.

In this instance, the authentication system according to another exemplary embodiment of the present disclosure may arbitrarily generate a one-time secret object each time authentication is required without receiving the setting of the secret object from the user, and may authenticate the user using the arbitrarily generated one-time secret object.

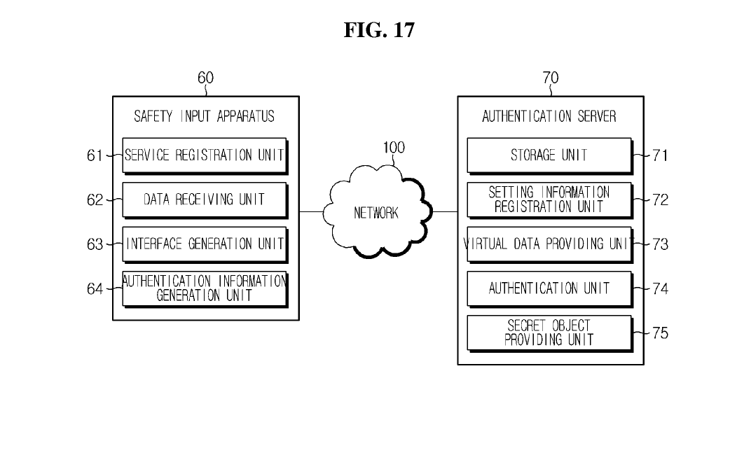

In the description of another exemplary embodiment of the present disclosure with reference to FIGS. 17 through 20, an overlapping description with the previous embodiment is abridged and briefly provided, and since elements having the same reference numbers as FIG. 9 perform the same function as the elements described with reference to FIG. 9 and its detailed description is omitted herein.

FIG. 17 is a diagram illustrating an authentication system, according to still another exemplary embodiment of the present disclosure.

As shown in FIG. 17, the authentication system according to still another exemplary embodiment of the present disclosure includes a safety input apparatus 60 and an authentication server 70.

The safety input apparatus 60 generates and displays an object selection interface in which a plurality of secret objects and a plurality of masquerading objects are placed at random and that allows an object movement, using the virtual data received from the authentication server 70. Also, when the arrangement of the objects on the object selection interface is completed, the safety input apparatus 60 requests user authentication to the authentication server 70 by generating authentication information in which a virtual code and location information are recorded for each object arranged on the object selection interface and transmitting it to the authentication server 70.

The safety input apparatus 60 includes a service registration unit 61, the data receiving unit 42, the interface generation unit 43, and the authentication information generation unit 44.

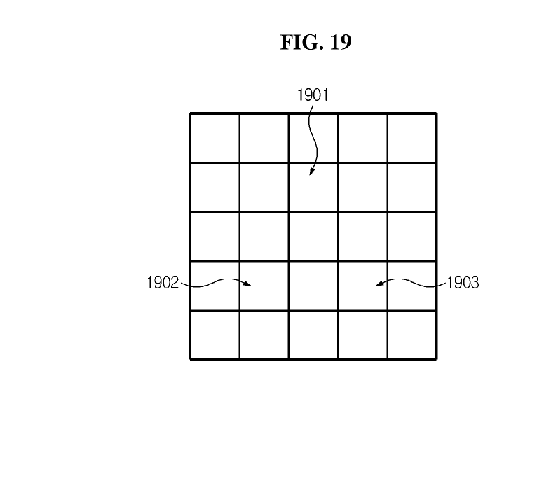

The service registration unit 61 performs a function of registering a security authentication service of the user on the authentication server 70. Specifically, after the user connects to the authentication server 70 and login authentication based on an ID and a password succeeds, the service registration unit 61 requests the security authentication service registration of the user to the authentication server 70. Also, the service registration unit 61 receives a location setting window (see FIG. 19) free of an object image from the authentication server 70, receives an input of location information where the secret object should be located through the location setting window from the user, and registers it on the authentication server 70. Additionally, the service registration unit 61 sequentially receives an input of lots of location information where a plurality of secret objects should be located from the user without receiving the setting of the secret objects from the user, and registers it on the authentication server 70.

The authentication server 70 is an authentication apparatus for authenticating the user, and performs a function of providing a security authentication service to the user.

The authentication server 70 includes a storage unit 71, a setting information registration unit 72, a virtual data providing unit 73, an authentication unit 74, and a secret object providing unit 75.

The storage unit 71 stores a login ID and a login password of the user, and maps location information where each secret object should be located and a seed value to the login ID of the user and stores it. Also, the storage unit 71 maps arrival information (for example, a mobile phone number) of a message receiving device designated by the user to the login ID of the user and additionally stores it. Also, the storage unit 71 stores an object pool in which a plurality of objects is registered.

The setting information registration unit 72 receives location information where each secret object should be located from the user, and stores the received location information of each secret object in the storage unit 71. Specifically, when the setting information registration unit 72 receives a request for a security authentication service from the safety input apparatus 60, the setting information registration unit 72 transmits a location setting window capable of setting the location information of the secret object to the safety input apparatus 60. Also, the setting information registration unit 72 receives the location information of each secret object sequentially selected by the user from the safety input apparatus 60, and maps the received location information of each secret object to the login ID of the user and stores it in the storage unit 71. In this instance, the setting information registration unit 72 ascertains an order of the location information set by the user, and stores the location information of the secret object in the storage unit 71 in the order. Also, the setting information registration unit 72 receives arrival information (for example, mobile communication terminal phone number) of a message receiving device from the user, and maps it to the login ID of the user and stores it in the storage unit 71.

The secret object providing unit 75 performs a function of providing the secret object to the safety input apparatus 60. Specifically, the secret object providing unit 75 sequentially selects a predetermined number of one-time secret objects from the object pool of the storage unit 71, ascertains the arrival information of the message receiving device of the user stored in the storage unit 71, and transmits a secret object notification message including the plurality of selected one-time secret objects to the message receiving device having the arrival information. In this instance, for the user to recognize an order of the selected one-time secret objects, the secret object providing unit 75 may separately mark an order (for example, 1, 2, 3, etc.) on each one-time secret object, or arrange the one-time secret objects in a left-to-right order of the objects and transmit it to the message receiving device. Preferably, the secret object providing unit 75 selects a new one-time secret object from the object pool of the storage unit 71 each time the safety input apparatus 60 attempts authentication.

The virtual data providing unit 73 performs a function of providing data necessary for safety login authentication to the safety input apparatus 60. Specifically, the virtual data providing unit 73 selects a predetermined number of masquerading objects from the object pool of the storage unit 71 respectively. In this instance, the virtual data providing unit 73 selects the masquerading objects among the objects except the one-time secret objects selected by the secret object providing unit 75. Also, the virtual data providing unit 73 generates a virtual URL for each selected one-time secret object and each masquerading object, and links the generated virtual URL with its corresponding object. Also, after the virtual data providing unit 73 generates a virtual code for each one-time secret object and each masquerading object, the virtual data providing unit 73 generates virtual data in which the generated virtual code and virtual URL are mapped for each object and transmit it to the safety input apparatus 60.

The authentication unit 74 not only performs login authentication based on the ID and the password, but also performs security authentication of the user by ascertaining whether the virtual code corresponding to each secret object is arranged at an appointed location through analysis of the authentication matrix received from the safety input apparatus 60. Specifically, the authentication unit 74 ascertains the virtual code of each one-time secret object generated by the virtual data providing unit 73 in the authentication matrix, and ascertains the location information of each secret object sequentially set by the user in the storage unit 71. Also, the authentication unit 74 authenticates the user by ascertaining each virtual code representing the one-time secret object in the authentication matrix based on the ascertained virtual code for each one-time secret object, and ascertaining, for each secret object, whether a location of each ascertained virtual code matches the location information of each secret object set by the user. That is, the authentication unit 74 verifies whether the virtual code representing the one-time secret object in the authentication matrix is correctly located at a location set by the user.

Also, when the user authentication is completed, the authentication unit 74 deletes the virtual URL, the virtual code, and the location information for each object generated by the virtual data providing unit 73. Also, when the user authentication succeeds, the authentication unit 44 may separately store an authentication time and the virtual code of the secret object as an authentication fingerprint in the storage unit 71.

In this instance, when the authentication unit 74 receives the encrypted and transformed authentication matrix from the safety input apparatus 60, the authentication unit 74 decrypts the encrypted authentication matrix, ascertains a seed value set by the user in storage unit 71, and recovers the authentication matrix using an inverse transform function to which the seed value is applied. Preferably, the seed value may be a login password of the user, the authentication unit 74 ascertains the login password of the user in the storage unit 71, and recovers the authentication matrix using an inverse transform function to which the login password is applied as the seed value.

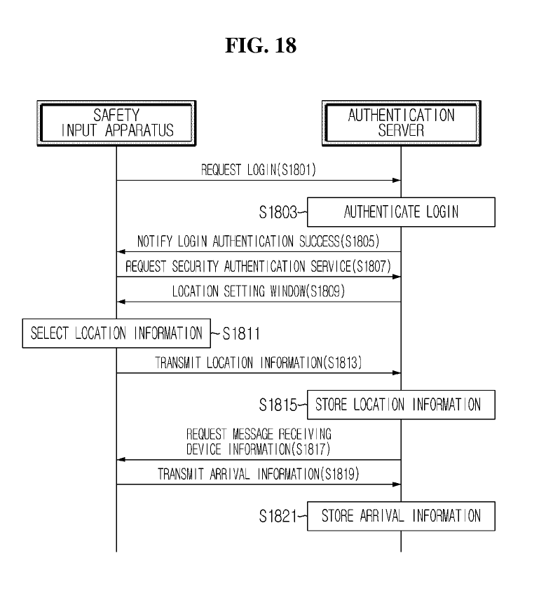

FIG. 18 is a flowchart illustrating a method of registering the user in the security authentication service in the authentication system, according to still another exemplary embodiment of the present disclosure.

Referring to FIG. 18, after the service registration unit 61 of the safety input apparatus 60 connects to the authentication server 70, the service registration unit 61 transmits a login request message including an ID and a password of the user to the authentication server 70 (S1801).

Then, the authentication unit 74 of the authentication server 70 performs login authentication of the user by extracting the ID and the password included in the login request message, and ascertaining whether the extracted ID and password are stored in the storage unit 71 as authentication information of the same user (S1803). Subsequently, when the login authentication of the user succeeds, the authentication unit 74 of the authentication server 70 transmits a login authentication success notification message to the safety input apparatus 60 (S1805).

Subsequently, when the safety input apparatus 60 succeeds the login authentication of the user, the service registration unit 61 receives an input of security authentication service registration from the user. In this case, the service registration unit 61 transmits a security authentication service request message to the authentication server 70 (S1807).

Then, the setting information registration unit 72 of the authentication server 70 transmits a location setting window capable of setting location information of the secret object to the safety input apparatus 60 (S1809). Subsequently, the service registration unit 61 of the safety input apparatus 60 displays the location setting window received from the authentication server 70.

FIG. 19 is a diagram illustrating the location setting window, and the setting information registration unit 72 may transmit a grid-type location setting window capable of designating location information without displaying an object as shown in FIG. 19 to the safety input apparatus 60. Also, the setting information registration unit 72 may transmit a circle-type location setting window as shown in FIG. 14b from which an object is removed to the safety input apparatus 60. That is, the setting information registration unit 72 may transmit, to the safety input apparatus 60, a location setting window in which an object is removed from an object selection interface to be provided to the user.

Subsequently, the service registration unit 61 of the safety input apparatus 60 sequentially receives a selection of location information where the secret object should be located from the user through the location setting window (S1811). Subsequently, the service registration unit 61 sequentially transmits the lots of location information sequentially inputted through the location setting window to the authentication server 70 in an order in which the selection is received (S1813).

Describing with reference to FIG. 19, when the user selects the coordinates in an order of 1901, 1902, and 1903 in the location setting window of FIG. 19, the service registration unit 61 transmits the location information in an order of (3,2), (2,4), and (4,4) to the authentication server 70.

Then, the setting information registration unit 72 of the authentication server 70 sequentially receives the lots of location information from the safety input apparatus 60, and maps the location information of each secret object to the login ID of the user in the receipt order and stores it in the storage unit 71 (S1815). Subsequently, the setting information registration unit 72 requests, to the safety input apparatus 60, arrival information (for example, a mobile phone number, an IP address, and the like) of a message receiving device destined to receive secret object notification message (S1817).

Subsequently, the safety input apparatus 60 transmits the arrival information of the message receiving device inputted from the user to the authentication server 70 (S1819). Then, the setting information registration unit 72 of the authentication server 70 maps the arrival information of the message receiving device received from the safety input apparatus 60 to the login ID and stores it in the storage unit 71 (S1821).

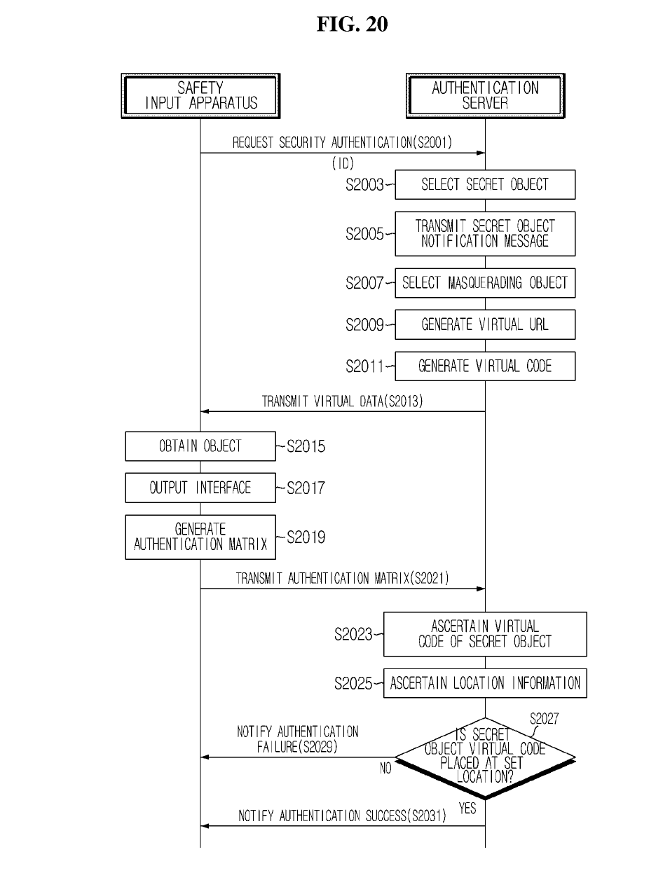

FIG. 20 is a flowchart illustrating a method of authenticating the user in the authentication system, according to still another exemplary embodiment of the present disclosure.

Referring to FIG. 20, the safety input apparatus 60 transmits the security authentication request message including the login ID of the user to the authentication server 70 (S2001). Then, the secret object providing unit 75 of the authentication server 70 selects a predetermined of one-time secret objects from the object pool of the storage unit 71 (S2003), and ascertains the arrival information of the message receiving device of the user stored in the storage unit 71.

Subsequently, the secret object providing unit 75 transmits a secret object notification message including the numerous selected one-time secret objects to the message receiving device having the arrival information (S2005). In this instance, for the user to recognize an order of the selected one-time secret objects, the secret object providing unit 75 may separately mark an order (for example, 1, 2, 3, etc.) on each one-time secret object, or arrange the one-time secret objects in a line such that a left-to-right order is significant. Preferably, the one-time secret object is included in an image type in the secret object notification message.

Subsequently, the virtual data providing unit 73 selects a predetermined number of masquerading objects from the object pool of the storage unit 71 respectively (S2007). In this instance, the virtual data providing unit 73 selects the masquerading objects among the objects except the one-time secret objects selected by the secret object providing unit 75.

Subsequently, the virtual data providing unit 73 generates a virtual URL for each selected one-time secret object and each masquerading object, and links each generated virtual URL with its corresponding object (that is, the masquerading object or the secret object) (S2009). Also, the virtual data providing unit 73 arbitrarily generates a one-time virtual code for each object, that is, for each one-time secret object and each masquerading object (S2011). Subsequently, the virtual data providing unit 73 transmits virtual data in which the virtual URL and the virtual code are mapped for each object to the safety input apparatus 60 (S2013).

Then, the interface generation unit 43 of the safety input apparatus 60 ascertains the virtual URL and the virtual code in the received virtual data. Also, the interface generation unit 43 gets access to each ascertained virtual URL and obtains each object (S2015). Subsequently, the interface generation unit 43 places the obtained object at random at an object display location implemented in the object selection interface, completing the generation of the object selection interface. Subsequently, the interface generation unit 43 displays the plurality of generated object selection interfaces (S2017).

When the object selection interface is outputted to the safety input apparatus 60, the user ascertains the plurality of one-time secret objects and an order of each one-time secret object through the secret object notification message received through the message receiving device, and moves each one-time secret object to a designated location based on the ascertained information. That is, the user ascertains a plurality of one-time secret objects currently set and a setting order of the one-time secret objects through the message receiving device, moves the one-time secret objects among the objects presented in the object selection interface at a designated location, that is, a location preset by the user in an order preset by the user, and inputs an arrangement complete menu.

Describing with reference to FIG. 14a, assuming the user sequentially sets location information (3,2), (2,4), and (4,4) of each secret object and registers it on the authentication server 70, and the secret object providing unit 75 of the authentication server 70 selects the one-time secret objects in an order of 1401a, 1402a, and 1403a. In this case, the secret object providing unit 75 transmits, to the message receiving device designated by the user, a secret object notification message in which the selected one-time secret objects are arranged from left to right in the order of 1401a, 1402a, and 1403b, and the user moves the first secret object 1401a to first location information (3,2) set by the user, second secret object 1402a to second location information (2,4) set by the user, and the third secret object 1403a to preset third location information (4,4), and inputs an object arrangement complete menu.

When the user completes the object movement on the object selection interface, the authentication information generation unit 44 of the safety input apparatus 60 generates an authentication matrix in which the virtual code for each object is arranged based on the location information (S2019). Subsequently, the authentication information generation unit 44 transmits the generated authentication matrix to the authentication server 70 (S2021).

Then, the authentication unit 74 of the authentication server 70 ascertains the one-time secret object selected by the secret object providing unit 75 and the order of the one-time secret object, and ascertains the virtual code of each one-time secret object (S2023). Subsequently, the authentication unit 74 ascertains the location information of each secret object sequentially set by the user in the storage unit 71 (S2025). That is, the authentication unit 74 ascertains the location information of each secret object mapped to the login ID of the user in the storage unit 71.

Subsequently, the authentication unit 74 authenticates the user by ascertaining each virtual code representing the one-time secret object in the authentication matrix based on the ascertained virtual code for each one-time secret object, and ascertaining, for each secret object, whether a location of each ascertained virtual code matches the location information of each secret object set by the user (S2027). That is, the authentication unit 74 verifies whether the virtual code representing the one-time secret object in the authentication matrix is sequentially located at a location set by the user.

Subsequently, when any one of the virtual codes of the secret objects is not arranged at the location preset by the user, the authentication unit 74 determines the user authentication for the safety input apparatus 60 as a failure, and transmits an authentication failure notification message to the safety input apparatus 60 (S2029).

In contrast, when the virtual code for each secret object is arranged at the location preset by the user in the authentication matrix, the authentication unit 74 determines the user authentication for the safety input apparatus 60 as a success, transmits an authentication success notification message to the safety input apparatus 60 (S2031), and provides a service requested from the user. Also, when the user authentication is completed, the authentication unit 74 deletes the virtual URL and the virtual code for each object generated by the virtual data providing unit 73.

In this instance, the authentication unit 74 may authenticate the user by ascertaining the virtual code representing the secret object in the authentication matrix and ascertaining whether the virtual code for each secret object is consecutively arranged in the authentication matrix. That is, similar to the fixed arrangement scheme according to the previous embodiment of the present disclosure, the authentication unit 74 may authenticate the user by ascertaining whether the virtual code of each secret object is consecutively arranged in the authentication matrix. In this case, the setting information registration unit 72 does not require the location information of each secret object to the user and the storage unit 71 does not store the location information of each secret object.

Although the foregoing embodiments describe that the safety input apparatus 40 and 60 transmit one authentication matrix to the authentication servers 50 and 70 and the authentication servers 50 and 70 authenticate the user by ascertaining whether the virtual code for each secret object is arranged at an appointed location through one authentication matrix, the safety input apparatus 40 and 60 generates the authentication matrix in proportion to a number of secret objects and transmit it to the authentication servers 50 and 70, and the authentication servers 50 and 70 may authenticate the user by analyzing each authentication matrix.

Specifically, when the user moves a first secret object on the object selection interface and inputs an arrangement complete menu for the first secret object, the authentication information generation unit 44 of the safety input apparatus 40 and 60 generates a first authentication matrix in which the virtual code for each object is arranged based on the location information. Also, when the user moves a second secret object on the object selection interface and inputs an arrangement complete menu for the second secret object, the authentication information generation unit 44 of the safety input apparatus 40 and 60 generates a second authentication matrix in which for the virtual code for each object is arranged based on the location information. Also, the authentication information generation unit 44 requests user authentication by transmitting a plurality of authentication matrixes generated based on the arrangement of each secret object to the authentication servers 50 and 70.

In another embodiment in which a plurality of authentication matrixes are generated corresponding to a number of secret objects, when the user moves a particular object, the object selection interface moves the particular object and moves all the other objects on the object selection interface together to the movement distance of the particular object, thereby protecting the secret object of the user from a sniffing attack. For example, in FIG. 14a, when an object having reference number 1401a moves one block to the right, all other objects move one block to the right together. As another example, in FIG. 14b, when an object having reference numeral 1401b placed at the outermost circle moves two blocks in a clockwise direction, objects placed in the other two circles as well as other objects placed in the outermost circle also rotate two blocks in the clockwise direction.

Also, when the authentication units 54 and 74 of the authentication servers 50 and 70 receive a plurality of authentication matrixes from the safety input apparatus 40 and 60, the authentication units 54 and 74 authenticate the user by analyzing the plurality of authentication matrixes. Specifically, when a secret object arrangement scheme is a user designated arrangement scheme or a variable arrangement scheme and the plurality of authentication matrixes is received from the safety input apparatus 40 and 60, the authentication units 54 and 74 ascertains whether the virtual code of the first secret object is arranged at a designated location in the virtual code for each object recorded in the first authentication matrix, and similarly, whether the virtual code of the second secret object is arranged at a designated location in the virtual code for each object recorded in the second authentication matrix. Also, when the virtual code of the corresponding secret object is correctly arranged in each of the plurality of authentication matrixes, the authentication units 54 and 74 determines the user authentication as a success.

In this instance, when the plurality of authentication matrixes are received from the safety input apparatus 40 and 60, the authentication units 54 and 74 ascertains a location of the virtual code of the first secret object in the first authentication matrix and a location of the virtual code of the second secret object in the second authentication matrix. That is, the authentication units 54 and 74 ascertain the location at which the virtual code of the secret object is placed in a corresponding order in each authentication matrix. Also, the authentication units 54 and 74 may authenticate the user by determining whether the virtual code of the secret object ascertained in each authentication matrix has a consecutive location based on a row or column. For example, when the user sets three secret objects, the authentication servers 50 and 70 receive three consecutive authentication matrixes from the safety input apparatus 40 and 60, the authentication units 24 and 54 of the authentication servers 20 and 50 ascertain a location of the virtual code of the first secret object in the first authentication matrix and a location of the virtual code of each of the second secret object and the third secret object in the second authentication matrix and the third authentication matrix, respectively. Also, the authentication units 54 and 74 authenticate the user by ascertaining whether the ascertained locations of the first through third virtual codes have a consecutive location based on a row or column.

In this instance, although the foregoing embodiments describe that the safety input apparatus 10 and 40 generate an authentication matrix as authentication information of the user and transmit it to the authentication servers 20 and 50, the present disclosure is not limited thereto and any data including the location information and the virtual code of the object may be, without limitation, employed as the authentication information of the present disclosure.

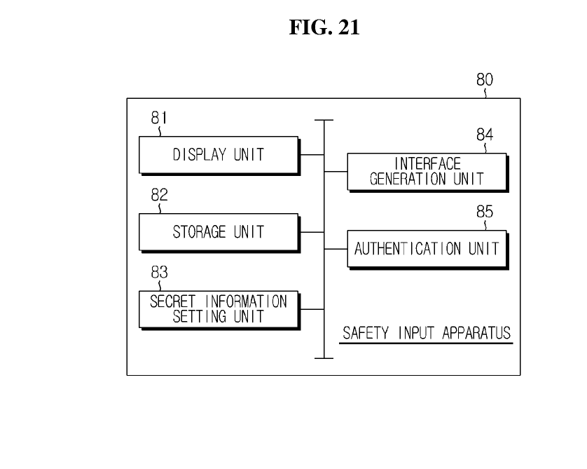

FIG. 21 is a diagram illustrating the safety input apparatus applied in a stand-alone environment, according to still another exemplary embodiment of the present disclosure.

As shown in FIG. 21, the safety input apparatus 80 according to another exemplary embodiment of the present disclosure includes a display unit 81, a storage unit 82, a secret information setting unit 83, an interface generation unit 84, and an authentication unit 85.

The display unit 81 is a display means based on LCD technology, LPD technology, LED technology, and the like, and outputs various information processed by the safety input apparatus 80. Also, the display unit 81 displays an object selection interface. The display unit 81 may be a touch display. In this case, the display unit 81 receives touch information of a user.

The storage unit 82 stores a plurality of secret objects and a secret object arrangement scheme (that is, a fixed arrangement scheme or a user designated arrangement scheme) set by the user. In this instance, when the user set a user designated arrangement scheme, the storage unit 82 additionally stores location information of each secret object. Also, the storage unit 82 stores an object pool in which a plurality of objects is registered.

The secret information setting unit 83 receives the setting of the secret object for each object selection interface from the user and stores it in the storage unit 82, and receives the setting of the object arrangement scheme from the user and stores it in the storage unit 82. Specifically, the secret information setting unit 83 outputs, to the display unit 81, a secret object selection window capable of setting at least one secret object among the plurality of objects registered in the object pool of the storage unit 82, and sequentially receives a selection of a plurality of secret objects from the user through the secret object selection window. Also, the secret information setting unit 83 stores the secret object in the storage unit 82 in an order in which the input of the secret object is received.

The interface generation unit 84 performs a function of generating a plurality of object selection interfaces and outputting it to the display unit 81. That is, the interface generation unit 84 ascertains the secret object for each object selection interface in the storage unit 82, and selects, for each object selection interface, a predetermined number of masquerading objects that is placed together with the secret object in the object selection interface from the object pool of the storage unit 82. Also, the interface generation unit 84 generates a plurality of object selection interfaces in which each corresponding secret object and masquerading object is placed and outputs it to the display unit 81.

The authentication unit 85 performs a function of authenticating the user by ascertaining the location of the object arranged in the object selection interface. Specifically, after the object selection interface is outputted to the display unit 81 by the interface generation unit 84, when the user arranges the object and inputs an arrangement complete signal, the authentication unit 85 ascertains in the storage unit 82 whether the secret object arrangement scheme set by the user is a fixed arrangement scheme or a user designated arrangement scheme, and ascertains the plurality of secret objects set by the user. When a fixed arrangement scheme is stored as the secret object arrangement scheme of the user in the storage unit 82, the authentication unit 85 performs user authentication by ascertaining whether the secret object set by the user (that is, the secret object stored in the storage unit) is consecutively arranged in the arrangement completed object selection interface. That is, when the secret object arrangement scheme set by the user is a fixed arrangement scheme, the authentication unit 85 ascertains whether each secret object is consecutively arranged at the same row, column or azimuth, and when the secret objects are consecutively arranged, determines the user authentication as a success.

In this instance, when a user designated arrangement scheme is stored as the secret object arrangement scheme of the user in the storage unit 82, the authentication unit 85 ascertains the location information of each secret object set by the user in the storage unit 82. Also, the authentication unit 85 performs user authentication by recognizing the location of each secret object in the arrangement completed object selection interface based on a plurality of secret object stored in the storage unit 82, and ascertaining, for each secret object, whether the recognized location of each secret object matches the location information of the secret object stored in the storage unit 82. When the location of each secret object arranged in the object selection interface correctly matches the location of each secret object stored in the storage unit 82, the authentication unit 85 determines the user authentication as a success.

While this specification contains many features, the features should not be construed as limitations on the scope of the disclosure or of the appended claims. Certain features described in the context of separate exemplary embodiments can also be implemented in combination in a single exemplary embodiment. Conversely, various features described in the context of a single exemplary embodiment can also be implemented in multiple exemplary embodiments separately or in any suitable subcombination.

Although the drawings describe the operations in a specific order, one should not interpret that the operations are performed in a specific order as shown in the drawings or successively performed in a continuous order, or all the operations are performed to obtain a desired result. Multitasking or parallel processing may be advantageous under a particular environment. Also, it should be understood that all exemplary embodiments do not require the distinction of various system components made in the above mentioned embodiment. The program components and systems may be generally implemented as a single software product or multiple software product packages.

The above mentioned method of the present disclosure may be implemented as program instructions and recorded in non-transitory computer-readable media (such as, for example, a compact disk-read only memory (CD ROM), random access memory (RAM), read-only memory (ROM), floppy disks, hard disks, magneto-optical disks, and the like). This process may be easily performed by person having ordinary skill in the technical field to which the present disclosure belongs, and its detailed description is omitted herein.

It should be noted various substitutions, modifications, and changes may be made to the present disclosure by person having ordinary skill in the technical field to which the present disclosure belongs without departing from the spirit and scope of the present disclosure, and the present disclosure is not limited by the above described embodiments and the accompanying drawings.

What is claimed is:

1. A security authorization method which performs security authentication of a user, the security authorization method comprising:
receiving, by a safety input apparatus, virtual data including a virtual code for each object from an authentication server;
outputting, by the safety input apparatus, a plurality of object selection interfaces in which each object is placed and a location of each object is changeable;
setting, by the safety input apparatus, when the location of each object is decided, a plurality of objects placed at the same location in each object selection interface as a combination set;
ascertaining, by the safety input apparatus, the virtual code of each object in the virtual data, and combining the virtual code of each object by the set combination set to generate a plurality of multi virtual codes distinguished by the combination set; and
transmitting, by the safety input apparatus, the plurality of generated multi virtual codes as authentication information of a user to the authentication server.

2. The security authorization method according to claim 1, further comprising:
after transmitting to the authentication server,
authenticating, by the authentication server, the user by ascertaining whether there is a multi virtual code corresponding to a stored authentication code among the plurality of multi virtual codes.

3. The security authorization method according to claim 2, further comprising:
before receiving the virtual data,
generating, by the authentication server, a virtual code for a plurality of secret objects and a plurality of masquerading objects; and
storing, by the authentication server, a multi virtual code in which the plurality of generated secret objects are combined, as the authentication code.

4. The security authorization method according to claim 3, wherein the generating of the virtual code further comprises generating, by the authentication server, a virtual uniform resource locator (URL) for each of the secret object and the masquerading object,
wherein the receiving of the virtual data comprises receiving, by the safety input apparatus, the virtual data including the virtual URL and the virtual code for each object from the authentication server.

5. The security authorization method according to claim 4, wherein the outputting of the object selection interface comprises ascertaining, by the safety input apparatus, a virtual URL for each object selection interface in the virtual data, and obtaining an object for each object selection interface through the virtual URL; and
arranging the obtained object in the corresponding interface respectively.

6. The security authorization method according to claim 2, wherein the transmitting to the authentication server comprises setting, by the safety input apparatus, a seed value set by the user as a seed of a transform function, transforming the plurality of multi virtual codes using the transform function, and transmitting the plurality of the transformed multi virtual codes to the authentication server,
wherein the authenticating of the user comprises extracting, by the authentication server, the seed value of the user, setting the seed value as a seed of an inverse transform function, recovering the plurality of transformed multi virtual codes, and ascertaining whether there is a multi virtual code corresponding to the stored authentication code among the plurality of recovered multi virtual codes.

7. The security authorization method according to claim 6, wherein the seed value set by the user is a login password of the user.

8. The security authorization method according to claim 1, wherein the outputting of the object selection interface comprises generating, by the safety input apparatus, display information of an object corresponding to a sound, arranging the display information of the object in the object selection interface, and when the display information of the object is clicked, playing the sound.

9. A safety input apparatus comprising:
an interface generation unit configured to receive virtual data including a virtual code for each object, and generate and output a plurality of object selection interfaces in which each object is placed and a location of each object is changeable; and
a multi virtual code generation unit configured to, when the location of each object is decided, set a plurality of objects placed at the same location in each object selection interface as a combination set, ascertain the virtual code of each object in the virtual data, and combine the virtual code of each object by the set combination set to generate a plurality of multi virtual codes distinguished by the combination set as authentication information of a user.

10. The safety input apparatus according to claim 9, wherein the interface generation unit ascertains a virtual URL for each object in the virtual data, obtains an object for each object selection interface through the virtual URL, and arranges each obtained object in the corresponding interface respectively.

11. The safety input apparatus according to claim 10, wherein the interface generation unit generates, when the virtual URL is a URL of a sound object, display information of the sound object, places the display information of the sound object in the object selection interface, and when the display information of the sound object is clicked, obtains a sound through the corresponding URL and plays the sound.

12. The safety input apparatus according to claim 9, further comprising:
a code transformation unit configured to set a seed value inputted from the user as a seed of a transform function, transform a plurality of multi virtual codes using the transformed function, and transmit the plurality of the transformed multi virtual codes to the authentication server.

13. The safety input apparatus according to claim 12, wherein the code transformation unit receives an input of a login password of the user as the seed value.

14. The security input apparatus according to claim 9, further comprising:
a service registration unit configured to receive a setting of a secret object for each object selection interface from the user, and register the set secret object for each object selection interface on the authentication server.

15. An authentication apparatus comprising:
a storage unit configured to store a plurality of secret objects set by a user;
a virtual data providing unit configured to generate a virtual code for each of the plurality of secret objects and a plurality of masquerading objects, and transmit virtual data including the generated virtual code of each object to a communication device of the user; and
an authentication unit configured to authenticate the user, when receiving a plurality of multi virtual codes generated by the communication device from the communication device based on an input signal of the user and the virtual data, by ascertaining whether there is a multi virtual code corresponding to an authentication code among the plurality of multi virtual codes.

16. The authentication apparatus according to claim 15, wherein the authentication unit authenticates the user by setting, as the authentication code, a multi virtual code in which virtual codes of the plurality of secret objects among the generated virtual codes are combined.

17. The authentication apparatus according to claim 15, wherein the virtual data providing unit generates a virtual URL for each of the secret object and the masquerading object, and transmits virtual data further including the generated virtual URL of each object to a communication device of the user.

18. The authentication apparatus according to claim 15, further comprising:
a recovery processing unit configured to extract a seed value set by the user, set the seed value as a seed of an inverse transform function, and recovers a plurality of multi virtual codes,
wherein the authentication unit ascertains whether there is a multi virtual code corresponding to the authentication code among the plurality of recovered multi virtual codes.

19. The authentication apparatus according to claim 15, further comprising:
a secret object registration unit configured to receive a setting a plurality of secret objects from the user and store the plurality of secret objects in the storage unit, or select the plurality of secret objects and transmits a message including the plurality of selected secret objects to a message receiving device designated by the user.

20. A safety input apparatus comprising:
a storage unit configured to store a plurality of secret objects set by a user;
an interface generation unit configured to generate and output a plurality of object selection interfaces in which each object is placed and a location of each object is changeable; and
an authentication unit configured to authenticate the user by, when the location of each object in the object selection interface is decided, setting a plurality of objects placed at the same location in each object selection interface as a group, and ascertaining whether there is a group including all of the plurality of secret objects stored in the storage unit among the set groups.

21. A security authorization method which performs security authentication of a user in an authentication system, the security authorization method comprising:
generating, by an authentication server, virtual data including a virtual code for each object and transmit the virtual data to a safety input apparatus;
outputting, by the safety input apparatus, an object selection interface in which each object is placed and a location of each object is changeable, based on the virtual data;
generating, by the safety input apparatus, when the location of each object is decided, at least one authentication information including the location information and the virtual code of each object placed in the object selection interface;
transmitting, by the safety input apparatus, the at least one generated authentication information to the authentication server; and
authenticating, by the authentication server, the user by analyzing the authentication information, and ascertaining whether the virtual code of each secret object set by the user has appointed location information.

22. The security authorization method according to claim 21, wherein the authenticating comprises authenticating, by the authentication server, the user by ascertaining whether the virtual code of each secret object set by the user in the authentication information has consecutive location information, when a secret object arrangement scheme set by the user is a fixed arrangement scheme.

23. The security authorization method according to claim 21, wherein the authenticating comprises:
ascertaining, by the authentication server, the location information of each secret object set by the user, when a secret object arrangement scheme set by the user is a user designated arrangement scheme; and
authenticating, by the authentication server, the user by ascertaining the virtual code representing each secret object and the location information of the virtual code in the authentication information, and ascertaining, for each secret object, whether the ascertained location information of each virtual code matches the location information of each secret object set by the user.

24. The security authorization method according to claim 21, further comprising:
before the authenticating,
ascertaining, by the authentication server, a secret object arrangement scheme set by the user, and when the secret object arrangement scheme of the user is a variable arrangement scheme, ascertaining a message destination set by the user; and
generating, by the authentication server, location information for each secret object where each secret object set by the user is to be located in the object selection interface, and transmitting the generated location information to the ascertained message destination,
wherein the authenticating comprises authenticating, by the authentication server, the user by ascertaining the virtual code representing each secret object and the location information of the virtual code in the authentication information, and ascertaining, for each secret object, the ascertained location information of each virtual code matches the generated location information for each secret object.

25. The security authorization method according to claim 24, wherein the transmitting comprises generating, by the authentication server, an image representing information at which each secret object is to be located as the location information for each secret object, and transmitting the image to the ascertained message destination.

26. The security authorization method according to claim 21, wherein the generating of the virtual data and transmitting of the virtual data to the safety input apparatus comprises:
ascertaining, by the authentication server, a plurality of secret objects set by the user; and
selecting, by the authentication server, a plurality of masquerading objects, and generating a virtual code for each of the secret object and the masquerading object.

27. The security authorization method according to claim 26, wherein the generating of the virtual data and transmitting of the virtual data to the safety input apparatus comprises:
generating, by the authentication server, a virtual URL for each of the secret object and the masquerading object, including the URL for each object in the virtual data, and transmitting the virtual data to the safety input apparatus, and
the outputting of the object selection interface comprises ascertaining, by the safety input apparatus, the virtual URL for each object in the virtual data, getting access to the virtual URL to obtain each object, arranging each object in the object selection interface, and outputting the object selection interface.

28. The security authorization method according to claim 21, wherein the generating of the authentication information comprises generating, by the safety input apparatus, the authentication information in proportion to a number of secret objects of the user,
wherein the authenticating of the user comprises ascertaining an order in which the authentication information is generated and an order in which the secret object is set by the user, ascertaining a virtual code of a corresponding secret object in authentication information having the same generation order as the setting order of the secret object, and ascertaining whether each ascertained virtual code has appointed location information.

29. An authentication apparatus comprising:
a storage unit configured to store a plurality of secret objects set by a user;
a virtual data providing unit configured to generate a virtual code for each of the plurality of secret objects and a plurality of masquerading objects, and transmit virtual data including the generated virtual code of each object to a communication device of the user; and
an authentication unit configured to authenticate the user by receiving authentication information including an arrangement location for each object and the virtual data from the communication device, analyzing the authentication information, and ascertaining whether the virtual code of each secret object has appointed location information.

30. The authentication apparatus according to claim 29, wherein the authentication unit authenticates the user by ascertaining the virtual code of each secret object set by the user in the authentication information has consecutive location information, when a secret object arrangement scheme set by the user is a fixed arrangement scheme.

31. The authentication apparatus according to claim 29, wherein the authentication unit authenticates the user, when a secret object arrangement scheme set by the user is a user designated arrangement scheme, by ascertaining location information of each secret object set by the user in the storage unit, ascertaining the virtual code representing each secret object and the location information of the virtual code in the authentication information, and ascertaining, for each secret object, whether the ascertained location information of each virtual code matches the location information of each secret object ascertained in the storage unit.

32. The authentication apparatus according to claim 29, wherein the virtual data providing unit ascertains, when a secret object arrangement scheme set by the user is a variable arrangement scheme, ascertaining a message destination set by the user in the storage unit, generates location information for each secret object where each secret object is to be located in the object selection interface, and transmits the generated location information to the ascertained message destination,
wherein the authentication unit authenticates the user by ascertaining the virtual code representing each secret object and the location information of the virtual code in the authentication information and ascertaining, for each secret object, the ascertained location information of each virtual code matches the location information for each secret object generated by the virtual data providing unit.

33. The authentication apparatus according to claim 32, wherein the virtual data providing unit generates an image representing formation at which each secret object is to be located as the location information for each secret object and transmits the image to the ascertained message destination.

34. The authentication apparatus according to claim 29, wherein the virtual data providing unit generates, by the authentication server, a virtual URL for each of the secret object and the masquerading object, includes the URL for each object in the virtual data, transmits the virtual data to the communication device.

35. The authentication apparatus according to claim 29, wherein the authentication unit receives a plurality of authentication information in proportion to a number of secret objects from the communication device, an order in which the plurality of authentication information is generated and an order in which the secret object is set by the user, ascertains a virtual code of a corresponding secret object in authentication information having the same generation order as the setting order of the secret object, and ascertains whether each ascertained virtual code has appointed location information.

36. A security authentication method which performs security authentication of a user in an authentication system, the security authentication method comprising:
selecting, by an authentication server, a plurality of secret objects in an object pool, and transmitting the selected secret objects to a message destination designated by a user;
generating, by the authentication server, virtual data including a virtual code for each object and transmitting the virtual data to a safety input apparatus;
outputting, by the safety input apparatus, an object selection interface in which each object is placed and a location of each object is changeable, based on the virtual data;
generating, by the safety input apparatus, when the location of each object is decided, at least one authentication information including the location information and the virtual code of each object placed in the object selection interface;
transmitting, by the safety input apparatus, the at least one generated authentication information to the authentication server; and
authenticating, by the authentication server, the user by analyzing the authentication information, and ascertaining whether the virtual code of each selected secret object has appointed location information.

37. The security authentication method according to claim 36, wherein the authenticating comprises:
ascertaining, by the authentication server, the location information of each secret object set by the user; and
authenticating, by the authentication server, the user by ascertaining the virtual code representing each secret object and the location information of the virtual code in the authentication information, and ascertaining, for each secret object, whether the ascertained location information of each virtual code matches the location information of each secret object set by the user.

38. The security authentication method according to claim 36, wherein the authenticating comprises ascertaining whether the virtual code of each selected secret object has consecutive location information.

39. The security authentication method according to claim 36, wherein the generating of the virtual data and the transmitting of the virtual data to the safety input apparatus comprises:
selecting, by the authentication server, a plurality of masquerading objects; and
generating, by the authentication server, a virtual code for each of the secret object and the masquerading object.

40. The security authentication method according to claim 39, wherein the generating of the virtual data and transmitting of the virtual data to the safety input apparatus comprises generating, by the authentication server, a virtual URL for each of the secret object and the masquerading object, including the URL for each object in the virtual data, and transmitting the virtual data to the safety input apparatus,
wherein the outputting of the object selection interface comprises ascertaining, by the safety input apparatus, the virtual URL for each object in the virtual data, getting access to the virtual URL to obtain each object, arranging each object in the object selection interface, and outputting the object selection interface.

41. An authentication apparatus comprising:
a storage unit configured to store an object pool;
a secret object providing unit configured to select a plurality of secret objects in the object pool of the storage unit, and transmit the selected secret objects to a message destination designated by a user;
a virtual data providing unit configured to select a plurality of masquerading objects in the object pool of the storage unit, generate a virtual code for each of the secret object and the masquerading object, and transmit virtual data including the generated virtual code of each object to a communication device of the user; and
an authentication unit configured to authenticate the user by receiving authentication information including an arrangement location for each object and the virtual data from the communication device, analyzing the authentication information, and ascertaining whether the virtual code of each secret object has appointed location information.

42. The authentication apparatus according to claim 41, wherein the authentication unit authenticates the user by ascertaining the location information of each secret object set by the user in the storage unit, ascertaining the virtual code representing each secret object and the location information of the virtual code in the authentication information, and ascertaining, for each secret object, whether the ascertained location information of each virtual code matches location information of each secret object ascertained in the storage unit.

43. The authentication apparatus according to claim 41, wherein the authentication unit authenticates the user by ascertaining whether the virtual code of each selected secret object has consecutive location information.

44. The authentication apparatus according to claim 41, wherein the virtual data providing unit generates a virtual URL for each the secret object and the masquerading object, includes the URL for each object in the virtual data, and transmits the virtual data to the communication device.

45. A safety input apparatus comprising:
a storage unit configured to store a plurality of secret objects set by a user;
an interface generation unit configured to generate and output a plurality of object selection interfaces in which each object is placed and a location of each object is changeable; and
an authentication unit configured to authenticate the user by ascertaining, when the location of each object in the object selection interface is decided, a secret object in each object selection interface, and ascertaining whether each secret object is located at an appointed location.

46. The safety input apparatus according to claim 45, wherein the authentication unit authenticates the user by ascertaining whether the secret object ascertained in the object selection interface is consecutively located, when a secret object arrangement scheme set by the user is a fixed arrangement scheme.

47. The safety input apparatus according to claim 45, wherein the authentication unit authenticates the user, when the secret object arrangement scheme set by the user is a user designated arrangement scheme, by ascertaining the location information of each secret object set by the user in the storage unit, and ascertaining, for each secret object, whether the location of each secret object ascertained in the object selection interface matches the location information of the secret object ascertained in the storage unit.
